(19) United States
(12) Patent Application Publication
(10) Pub. No.: US 2012/0002827 A1
(43) Pub. Date: Jan. 5, 2012

(54) SIGNAL PROCESSING SYSTEM AND SIGNAL PROCESSING METHOD

(75) Inventor: Masakazu OSHITANI, Kawasaki (JP)

(73) Assignee: FUJITSU LIMITED, Kawasaki (JP)

(21) Appl. No.: 13/105,216

(22) Filed: May 11, 2011

(30) Foreign Application Priority Data
Jul. 1, 2010 (JP) 2010-151320

(51) Int. Cl. H04R 5/02

(52) U.S. Cl. 381/300

(57) ABSTRACT

A signal processing system includes a transmitter, a sensor, a plurality of processing apparatuses, a placement determiner and a signal distributor. The transmitter transmits a wireless signal. The sensor detects the wireless signal transmitted by the transmitter. The plurality of processing apparatuses receives corresponding signals and executes processing on the received signals. The placement determiner determines placement of the processing apparatuses based on the detection of the wireless signal performed by the sensor. The signal distributor distributes and sends signals to the processing apparatuses respectively, on a basis of the placement determined by the placement determiner.

### CROSS-REFERENCE TO RELATED APPLICATIONS

This application is based upon and claims the benefit of priority from the prior Japanese Patent Application No. 2010-151320 filed on Jul. 1, 2010, the entire contents of which are incorporated herein by reference.

### FIELD

The disclosure herein relates to a signal processing system including a plurality of processing apparatuses that executes processing on signals and to a signal processing method.

### BACKGROUND

Speaker systems have been known that employ a plurality of speaker units having speakers to reproduce sound that offers a user a sense of realism. In many cases, in such speaker systems, audio signals representing sounds according to the positions of the speaker units including the speakers are input to the speakers. With this arrangement, sounds to be heard from the positions of the speaker units when the user is assumed to be in an actual sound field are generated by the speaker units, thereby realizing sound that offers a sense of realism.

### SUMMARY

According to an embodiment, a signal processing system includes a transmitter, a sensor, a plurality of processing apparatuses, a placement determiner and a signal distributor. The transmitter transmits a wireless signal. The sensor detects the wireless signal transmitted by the transmitter. The plurality of processing apparatuses receives corresponding signals and executes processing on the received signals. The placement determiner determines placement of the processing apparatuses based on the detection of the wireless signal performed by the sensor. The signal distributor distributes and sends signals to the processing apparatuses respectively, on a basis of the placement determined by the placement determiner.

The object and advantages of the various embodiments will be realized and attained by means of the elements and combinations particularly pointed out in the claims. It is to be understood that both the foregoing general description and the following detailed description are exemplary and explanatory and are not restrictive of the various embodiments, as claimed.

Additional aspects and/or advantages will be set forth in part in the description which follows and, in part, will be apparent from the description, or may be learned by practice of the various embodiments.

### BRIEF DESCRIPTION OF DRAWINGS

FIG. 1 is a schematic view illustrating a speaker system of a comparative example;

FIG. 2 is a block diagram illustrating the speaker system illustrated in FIG. 1;

FIG. 3 is a block diagram illustrating a first embodiment of a signal processing system and a speaker system;

FIG. 4 is a hierarchical diagram illustrating a second embodiment of a signal processing system and a speaker system;

FIG. 5 is a schematic view of the speaker system illustrated in FIG. 4;

FIG. 6 is a block diagram illustrating the speaker system illustrated in FIGS. 4 and 5;

FIG. 7 schematically illustrates exchange of radio-wave signals between two radio-wave receivers in a first speaker unit and a radio-wave transmitter in a second speaker unit;

FIG. 8 is a block diagram illustrating details of an output-channel switching controller illustrated in FIGS. 4 to 6;

FIG. 9 is a flowchart illustrating sound output processing performed by the speaker system illustrated in FIGS. 4 to 8;

FIG. 10 is a hierarchical diagram illustrating a third embodiment of a signal processing system and a speaker system;

FIG. 11 is a schematic view of the speaker system illustrated in FIG. 10;

FIG. 12 is a block diagram illustrating the speaker system illustrated in FIGS. 10 and 11;

FIG. 13 schematically illustrates a state in which test sound produced by a second speaker of a second speaker unit is detected by two microphones of a first speaker unit;

FIG. 14 is a block diagram illustrating details of an output-channel switching controller illustrated in FIGS. 10 to 12;

FIG. 15 is a flowchart illustrating sound output processing performed by the speaker system illustrated in FIGS. 10 to 14;

FIG. 16 is a hierarchical diagram illustrating a fourth embodiment of a signal processing system and a speaker system;

FIG. 17 is a schematic view of the speaker system illustrated in FIG. 16;

FIG. 18 is a block diagram illustrating the speaker system illustrated in FIGS. 16 and 17;

FIG. 19 schematically illustrates an operation performed by a wireless tag of a second speaker unit and a wireless receiver of a first speaker unit;

FIG. 20 is a block diagram illustrating details of an output-channel switching controller illustrated in FIGS. 16 to 18; and

FIG. 21 is a flowchart illustrating sound output processing performed by the speaker system illustrated in FIGS. 16 to 20.

### DETAILED DESCRIPTION OF EMBODIMENT(S)

Before specific embodiments of a signal processing system and a speaker system according to the present disclosure are described, a description will first be given of a comparative example to be compared with the embodiments.

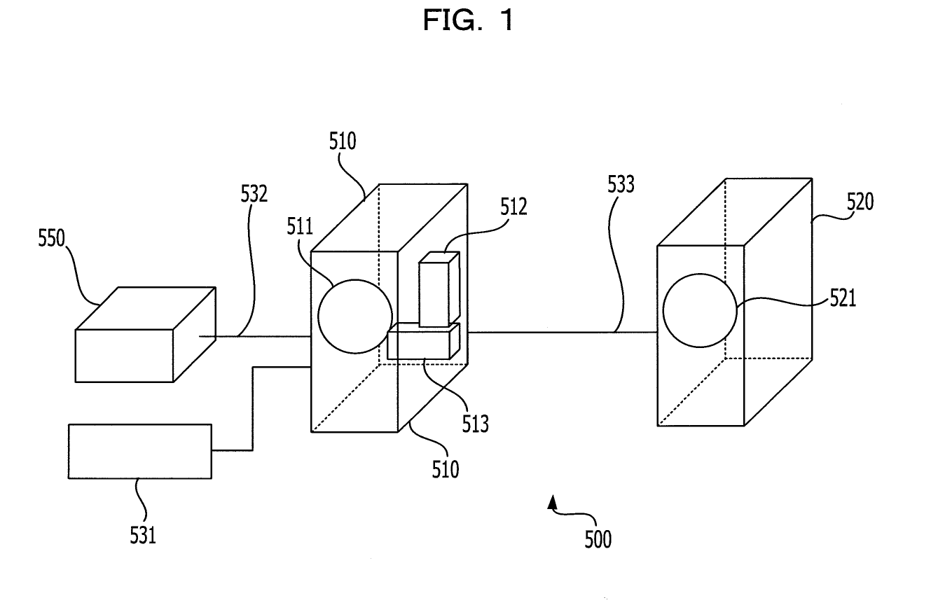

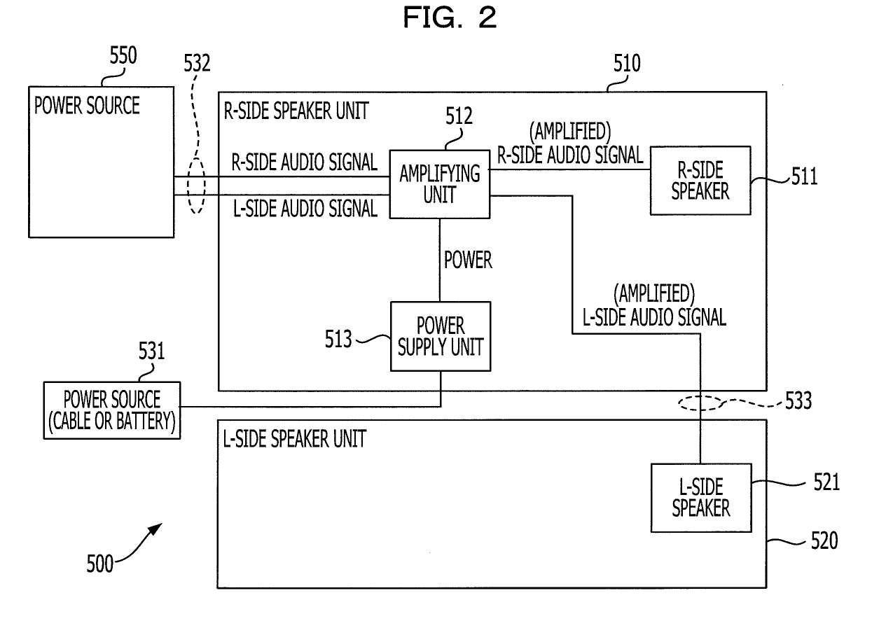

FIG. 1 is a schematic view illustrating a speaker system of a comparative example. FIG. 2 is a block diagram illustrating the speaker system illustrated in FIG. 1.

A speaker system 500 of the comparative example illustrated in FIGS. 1 and 2 is of a type in which two speaker units 510 and 520 are placed at the right and left sides so as to face a user who listens to sound.

In the speaker system 500 of the comparative example and a speaker system of an embodiment described below, expressions “right side” and “left side” in the system refer to the right side and the left side, respectively, when the user is viewed from the speaker units facing the user.

FIG. 1 illustrates a state in which the speaker system 500 of the comparative example is viewed from the user side. Thus, for describing embodiments of invention, the left side and the right side that appear in FIG. 1 and the left side and right side view from the user side in the speaker system 500 of the representative example are opposite to each other.

Two speaker units 510 and 520 include speakers 511 and 521, respectively. Hereinafter, the speaker unit 510 is placed at the right side and is referred to as “R-side speaker unit 510”, and the speaker 511 included in the R-side speaker unit 510 is referred to as “R-side speaker 511”. The speaker unit 520 is placed at the left side and is referred to as “L-side speaker unit 520”, and the speaker 521 included in the L-side speaker unit 520 is referred to as “L-side speaker 521”.

The speaker system 500 of the comparative example further includes a power source 531, a first connection cable 532, and a second connection cable 533.

The power source 531 feeds power to the speaker system 500 of the comparative example. The power source 531 may be, but is not limited to, a power-supply cable for feeding commercial power or a direct-current (DC) power source having a battery for feeding DC power. The power source 531 is coupled to the R-side speaker unit 510.

The first connection cable 532 provides connection between a sound-source apparatus 550 and the speaker system 500 of the comparative example. The sound-source apparatus 550 may be, but is not limited to, a television unit or a drive for accessing a recording medium on which music, a movie, or the like is recorded. The sound-source apparatus 550 outputs audio signals representing sounds to be produced by the speakers in the speaker units. The audio signals output from the sound-source apparatus 550 are input to the speaker system 500 of the comparative example through the first connection cable 532.

In other words, the sound-source apparatus 550 is coupled to the R-side speaker unit 510 through the first connection cable 532. The audio signals output from the sound-source apparatus 550 include an audio signal (a R-side audio signal) for the R-side speaker 511 located at the right side and an audio signal (a L-side audio signal) for the L-side speaker 521 located at the left side. Both of the R-side audio signal and the L-side audio signal output from the sound-source apparatus 550 are input to the R-side speaker unit 510 through the first connection cable 532.

The second connection cable 533 provides interconnection between the R-side speaker unit 510 and the L-side speaker unit 520.

The R-side speaker unit 510 includes an amplifying unit 512 and a power-supply unit 513, in addition to the R-side speaker 511.

The R-side audio signal and the L-side audio signal output from the sound-source apparatus 550 are input to the amplifying unit 512. The amplifying unit 512 amplifies those two audio signals. The amplifying unit 512 inputs the amplified R-side audio signal to the R-side speaker 511. The amplifying unit 512 also inputs the amplified L-side audio signal to the L-side speaker 521 of the L-side speaker unit 520 through the second connection cable 533.

For example, the power-supply unit 513 receives commercial AC power, performs power conversion processing for converting the AC power into DC power having a magnitude that can be used by the amplifying unit 512, and supplies the resulting DC power to the amplifying unit 512.

In the speaker system 500 of the comparative example described above, the R-side speaker 511 produces sound for the right side in a sound field and the L-side speaker 521 produces sound for the left side in the sound field. With this arrangement, the speaker system 500 of the comparative example produces sound that offers the user a sense of realism as if he or she were listening in the sound field.

In order to produce sound that offers the user a realistic and natural sensation without disturbing sound in the sound filed, it is necessary to ensure that the R-side speaker unit 510 is placed at the right side and the L-side speaker unit 520 is placed at the left side.

For simplicity of description, the speaker system 500 including two speaker units 510 and 520 is exemplified in the comparative example. In recent years, however, demands for sound that offers a greater sense of realism are increasing, and thus the number of speaker units included in the speaker system, such as a 5.1 channel surround system or the like, tends to increase.

Many of users who use such speaker systems are novice in audio equipment, and thus, under the situation, misplacement of the speaker units can easily occur. When the speaker units are placed at wrong positions, the user feels an odd sensation with sound heard from the speaker system.

In the comparative example, the degree of freedom in the placement of the speaker units in the speaker system is low. However, not only such speaker systems but also some other systems are low in the degree of placement. One example is a system in which display apparatuses are placed at respective predetermined positions and images corresponding to the positions are displayed on the display apparatuses. In such a system, when the display apparatuses are placed at wrong positions, the user may feel an odd sensation with images displayed on the display apparatuses. For example, another possible example is a system in which a plurality of computer apparatuses are placed at respective predetermined positions and signals corresponding to the positions are sent to the computer apparatuses for processing. In such a system, when the computer apparatuses are placed at wrong positions, the user may feel an odd sensation with results of the processing performed by the computer apparatuses. Thus, a low degree of freedom in the placement can also occur in a signal processing system having a plurality of processing apparatuses that execute processing on corresponding signals.

Embodiments of a signal processing system and a speaker system according to the present disclosure allow arbitrary placement of processing apparatuses so that, not matter how the processing apparatuses are placed, processing that does not give an odd sensation is executed. The present embodiment allows the arbitrary placement of the speaker units such that, for example, no matter how the user places the speaker units, sound that does not give an odd sensation is produced.

Next, a description will be given of a first embodiment of a signal processing system and a speaker system according to the present disclosure.

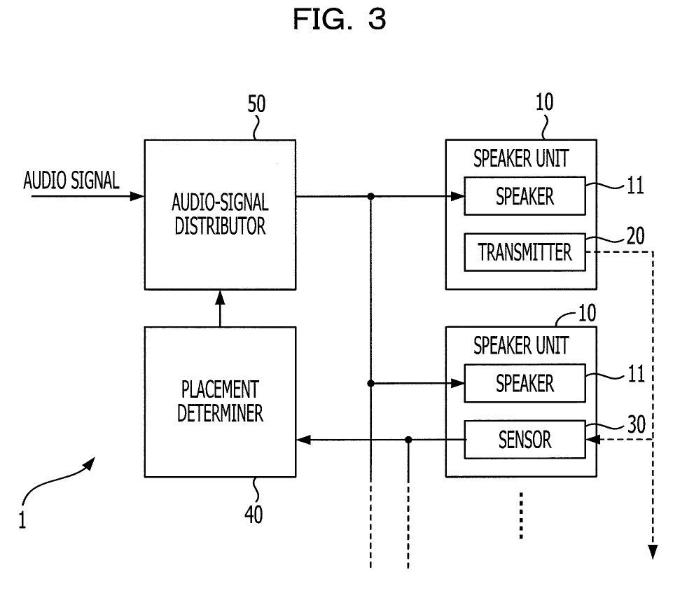

FIG. 3 is a block diagram illustrating a first embodiment of a signal processing system and a speaker system.

More specifically, FIG. 3 illustrates a speaker system 1 including a plurality of speaker units 10 as one embodiment of a signal processing system including a plurality of processing apparatuses that execute processing on respectively received signals.

The speaker system 1 illustrated in FIG. 3 includes the speaker units 10, a transmitter 20, a sensor 30, a placement determiner 40, and an audio-signal distributor 50.

Each of the speaker units 10 receives an audio signal representing sound and includes a speaker 11 for outputting the sound represented by the audio signal.

The transmitter 20 transmits a wireless signal for apparatus placement determination.

The wireless signal refers to a signal utilizing a medium (such as radio waves, sound, infrared, or light) that is wirelessly transmitted.

The sensor 30 detects the wireless signal transmitted by the transmitter 20.

In the speaker system 1, each of the speaker units 10 has at least one of the transmitter 20 and the sensor 30.

Each speaker unit having at least one of the transmitter and the sensor means that there is no speaker unit that lacks both the transmitter and the sensor. Thus, this form includes, in addition to the form (illustrated in FIG. 3) in which one speaker unit has the transmitter and another speaker unit has the sensor, a form in which each of the speaker units has both the transmitter and the sensor, a form in which all of the speaker units include only the transmitters, and a form in which all of the speaker units include only the sensors. In the form in which all of the speaker units include only the transmitters, the sensor that is not included in the speaker units is provided independently from the speaker units. Similarly, in the form in which all of the speakers include only the sensors, the transmitter that is not included in the speaker units are provided independently from the speaker units.

The placement determiner 40 determines the placement of the speaker units 10, on the basis of the wireless-signal detection performed by the sensor 30.

On the basis of the placement determined by the placement determiner 40, the audio-signal distributor 50 distributes and sends the audio signals to the speakers 11 included in the speaker units 10.

The speaker system 1 of the first embodiment actually measures the locations of the speaker units. On the basis of the actually measured locations, the audio signals for the speakers 11 are distributed. Thus, in the speaker system 1 of the first embodiment, the audio signals are distributed based on the actual placement of the speaker units 10. Consequently, the speakers 11 in the speaker units 10 produce sounds, which are to be heard from the speaker units 10. This realizes production of sound that does not give the user an odd sensation. In addition, according to the speaker system 1, no matter how the user places the speaker units 10, the positions of the speaker units 10 are actually measured and the actual measurement is reflected in the targets to which the audio signals are distributed. That is, since the speaker system 1 allows the user to place the speaker units 10 in any arrangement, he or she can arbitrarily place the speaker units 10. Thus, the degree of freedom in the placement of the speaker units 10 increases.

Next, a description will be given of a second embodiment of a signal processing system and a speaker system according to the present disclosure.

In the second embodiment, a speaker system including a plurality of speaker units is exemplified as one embodiment of the signal processing system including the plurality of processing apparatuses that execute processing on respectively received signals, as in the first embodiment described above. In the second embodiment, for simplicity of description, a speaker system including two speaker units is exemplified, as in the above-described comparative example.

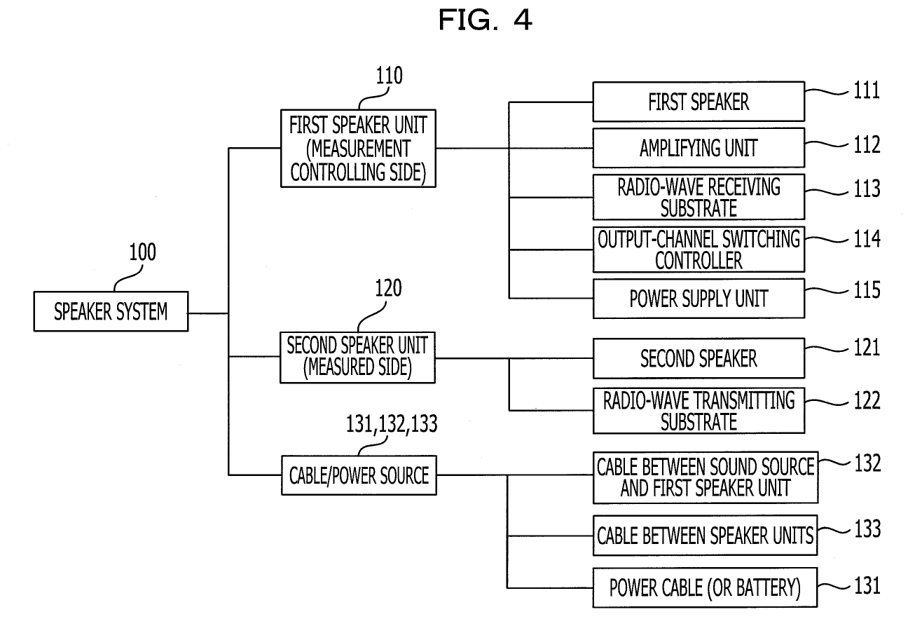

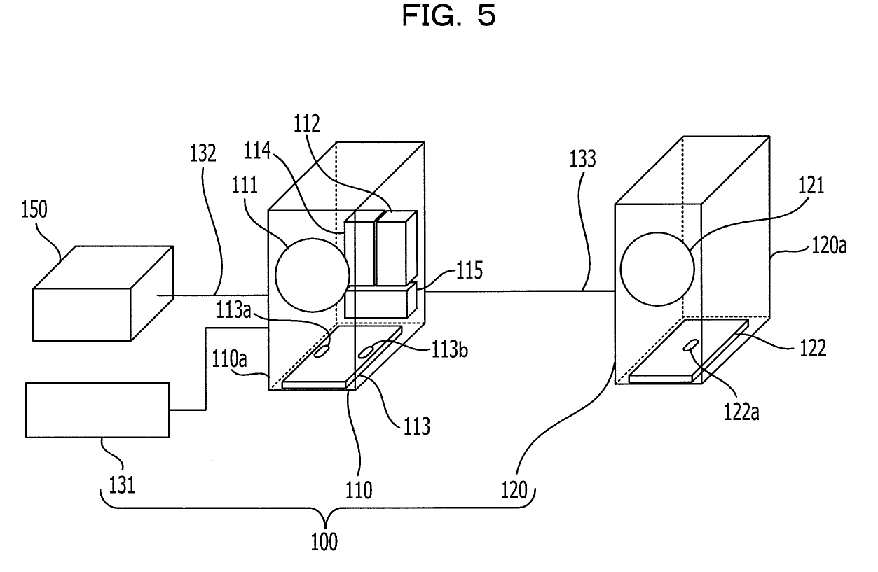

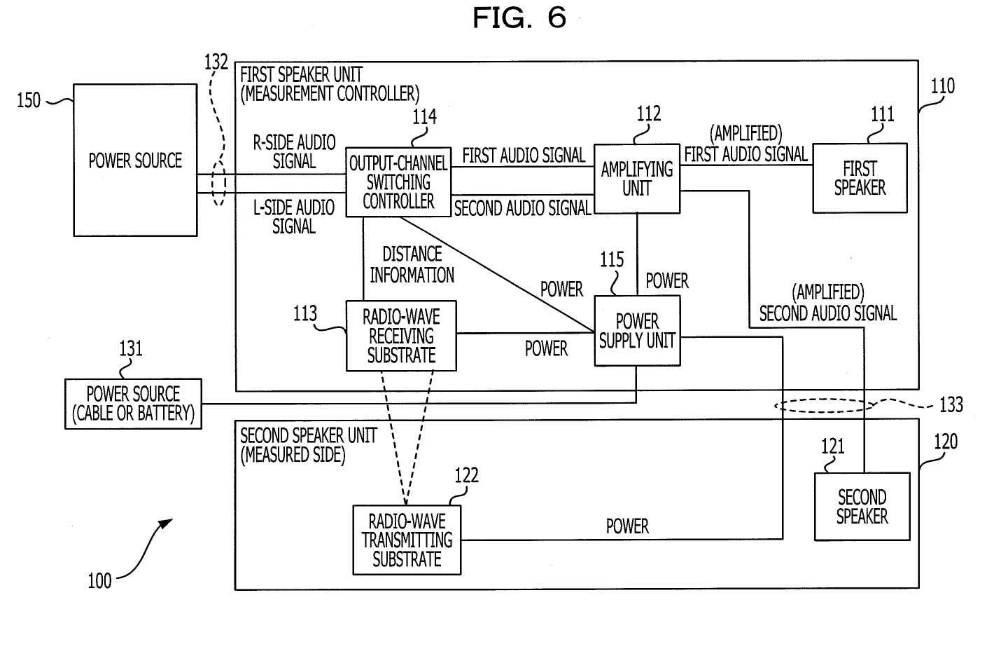

FIG. 4 is a hierarchical diagram illustrating the second embodiment of the signal processing system and the speaker system. FIG. 5 is a schematic view of the speaker system illustrated in FIG. 4. FIG. 6 is a block diagram illustrating the speaker system illustrated in FIGS. 4 and 5.

A speaker system 100 illustrated in FIGS. 4 to 6 is of a type in which a first speaker unit 110 and a second speaker unit 120 are placed at the right and left sides so as to face the user. The first speaker unit 110 includes a first speaker 111 and the second speaker unit 120 includes a second speaker 121. The second speaker 121 is substantially equivalent to the first speaker 111.

In the second embodiment, expressions “right side” and “left side” in the system refer to the right side and the left side, respectively, when the user is viewed from the speaker units facing the user, as described above with reference to FIG. 1.

Each of the first and second speaker units 110 and 120 in the second embodiment is one example of a processing apparatus that receives a signal and executes processing on the signal.

Each of the first and second speaker units 110 and 120 is one example of a speaker unit that receives an audio signal representing sound and that includes a speaker for producing the sound represented by the audio signal.

In the second embodiment, two speaker units 110 and 120 correspond to both one example of the plurality of processing apparatuses and one example of the plurality of speaker units. That is, in the second embodiment, a number “two” is exemplified as one example of a plurality.

The speaker system 100 includes a power source 131, a first connection cable 132, and a second connection cable 133.

The power source 131 feeds power to the speaker system 100. The power source 131 may be, but is not limited to, a power-supply cable for feeding commercial power or a DC power source having a battery for feeding DC power. The power source 131 is coupled to the first speaker unit 110.

The first connection cable 132 provides connection between a sound-source apparatus 150 and the speaker system 100. The sound-source apparatus 150 may be, but is not limited to, an audio-signal outputting apparatus, such as a television unit or a drive for accessing a recording medium on which music, a movie, or the like is recorded. The sound-source apparatus 150 is coupled to the first speaker unit 110 through the first connection cable 132. As the aforementioned audio signals, two audio signals, i.e., a R-side audio signal and a L-side audio signal, are output from the sound-source apparatus 150. The R-side audio signal represents sound to be heard from the R-side speaker and the L-side audio signal represents sound to be heard from the L-side speaker. Both of the R-side audio signal and the L-side audio signal output from the sound-source apparatus 150 are input to the first speaker unit 110 through the first connection cable 132.

The second connection cable 133 provides interconnection between the first speaker unit 110 and the second speaker unit 120.

The first speaker unit 110 includes an amplifying unit 112, a radio-wave receiving substrate 113, an output-channel switching controller 114, and a power supply unit 115, in addition to the first speaker 111.

The second speaker unit 120 includes a radio-wave transmitting substrate 122, in addition to the second speaker 121.

An audio signal (a first audio signal) for the first speaker 111 and an audio signal (a second audio signal) for the second speaker 121 are input from the output-channel switching controller 114 to the amplifying unit 112, as described below. The amplifying unit 112 amplifies the two audio signals. The amplifying unit 112 inputs the amplified first audio signal to the first speaker 111, and inputs the second audio signal to the second speaker 121 through the second connection cable 133.

The radio-wave receiving substrate 113 has two radio-wave receivers 113a and 113b. As schematically illustrated in FIG. 5, the radio-wave receiving substrate 113 is provided in a housing 110a of the first speaker unit 110. More specifically, the radio-wave receiving substrate 113 is provided at substantially the center of a bottom plate of the housing 110a of the first speaker unit 110. The radio-wave receiving substrate 113 is positioned in the first speaker unit 110 so that the two radio-wave receivers 113a and 113b are arranged in the right and left directions.

The radio-wave transmitting substrate 122 in the second speaker unit 120 has one radio-wave transmitter 122a. As schematically illustrated in FIG. 5, the radio-wave transmitting substrate 122 is provided in a housing 120a of the second speaker unit 120 so that the radio-wave transmitter 122a is provided at substantially the center of a bottom plate of the housing 120a.

In the second embodiment, radio-wave signals are exchanged between the two radio-wave receivers 113a and 113b in the first speaker unit 110 and the radio-wave transmitter 122a in the second speaker unit 120, as described below.

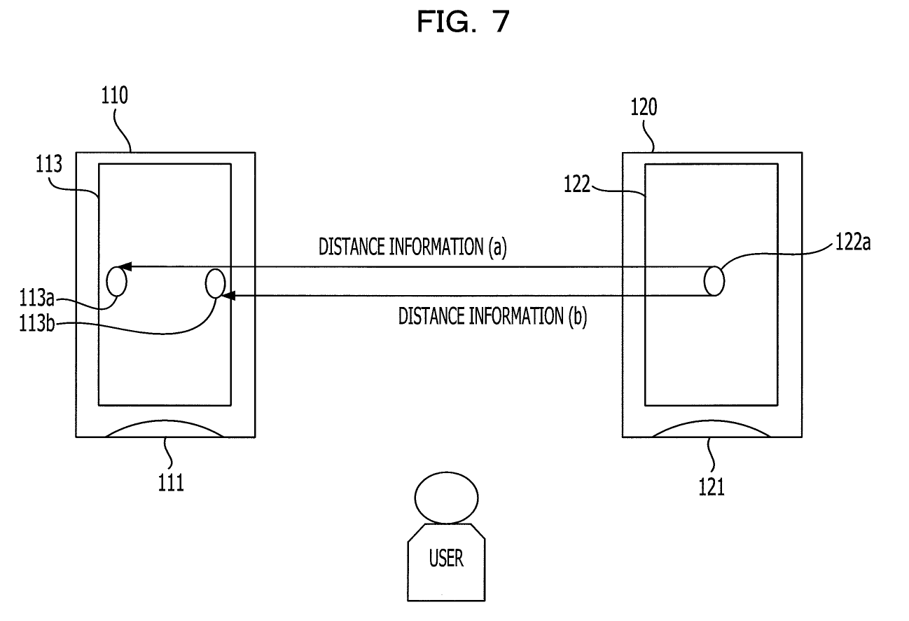

FIG. 7 schematically illustrates exchange of radio-wave signals between the two radio-wave receivers in the first speaker unit and the radio-wave transmitter in the second speaker unit.

When power is supplied from the power supply unit 115 in the first speaker unit 110 to the radio-wave transmitting substrate 122 in the second speaker unit 120, the radio-wave transmitter 122a transmits a radio-wave signal with a predetermined strength for a predetermined amount of time from the point of time of the power supply. The radio-wave transmitter 122a is an omnidirectional transmitter and thus transmits a radio-wave signal omnidirectionally. The signal strength of the radio-wave signal decreases as the distance from the radio-wave transmitter 122a increases. That is, the radio-wave signal carries, as the signal strength, distance information indicating the distance from the radio-wave transmitter 122a. The radio-wave signal is received by the two radio-wave receivers 113a and 113b provided on the radio-wave receiving substrate 113 in the first speaker unit 110.

The radio-wave transmitter 122a in the second embodiment is one example of a transmitter that transmits a wireless signal. Each of the two radio-wave receivers 113a and 113b in the second embodiment is one example of a sensor that detects the wireless signal transmitted by the transmitter. In the second embodiment, the radio-wave signal transmitted from the radio-wave transmitter 122a and received by the two radio-wave receivers 113a and 113b is one example of a wireless signal.

As described above, the radio-wave receiving substrate 113 is provided in the housing 110a so that the two radio-wave receivers 113a and 113b are arranged at the right and left sides in the first speaker unit 110.

In the example of FIG. 7, the second speaker unit 120 is placed at the left side of the first speaker unit 110 toward the user. That is, the radio-wave transmitter 122a in the second speaker unit 120 is located at the left side of the user, when viewed from the two radio-wave receivers 113a and 113b arranged at the right and left sides in the first speaker unit 110. As a result, the distance between the radio-wave receiver 113a at the right side and the radio-wave transmitter 122a is larger than the distance between the radio-wave receiver 113b at the left side and the radio-wave transmitter 122a. As described above, the signal strength of the radio-wave signal decreases as the distance from the radio-wave transmitter 122a increases and the radio-wave signal thus carries, as the signal strength, distance information indicating the distance from the radio-wave transmitter 122a. Thus, in the example of FIG. 7, the reception strength of the radio-wave signal received by the radio-wave receiver 113a at the right side facing the user is smaller than the reception strength of the radio-wave signal received by the radio-wave receiver 113b at the left side facing the user.

A description will now be given of a case in which the second speaker unit 120 is placed at the right side of the first speaker unit 110 toward the user, as opposed to the example of FIG. 7. This arrangement corresponds to a case in which the radio-wave transmitter 122a is located at the right side of the user, when viewed from the two radio-wave receivers 113a and 113b. In this case, the distance between the radio-wave receiver 113a at the right side and the radio-wave transmitter 122a is smaller than the distance between the radio-wave receiver 113b at the left side and the radio-wave transmitter 122a. Thus, in this example, the reception strength of the radio-wave signal received by the radio-wave receiver 113a at the right side facing the user is greater than the reception strength of the radio-wave signal received by the radio-wave receiver 113b at the left side facing the user.

By using the reception strengths of the radio-wave signals received by the two radio-wave receivers 113a and 113b, the output-channel switching controller 114 illustrated in FIGS. 4 to 6 distributes each of the R-side audio signal and the L-side audio signal as a signal for one of the two speakers 111 and 121. How the audio signals are distributed is described below in detail.

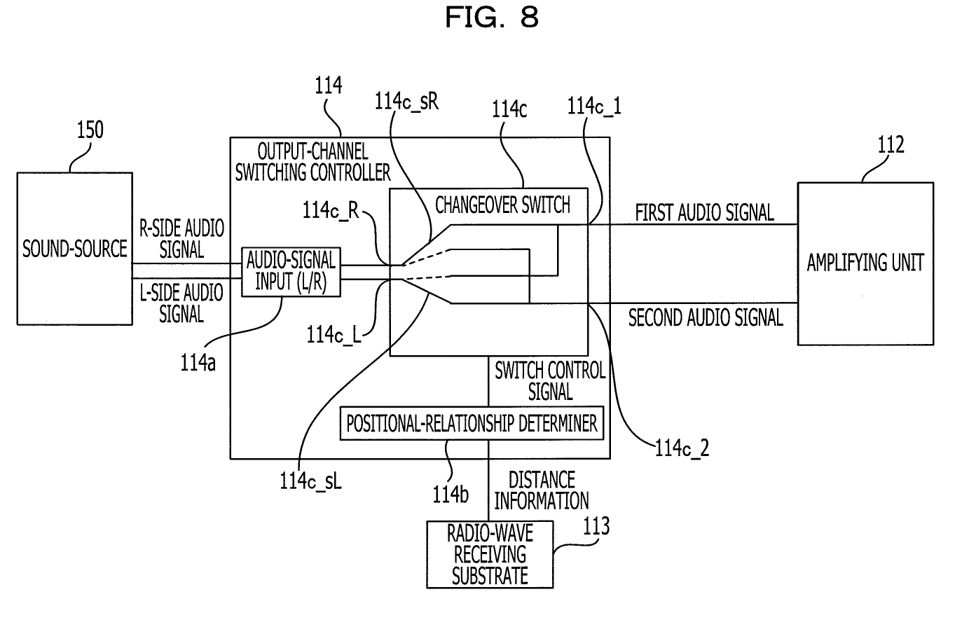

FIG. 8 is a block diagram illustrating details of the output-channel switching controller illustrated in FIGS. 4 to 6.

As illustrated in FIG. 8, the output-channel switching controller 114 includes an audio-signal input unit 114a, a positional-relationship determiner 114b, and a changeover switch 114c.

The R-side audio signal and the L-side audio signal from the sound-source apparatus 150 are input to the audio-signal input unit 114a, which then sends the input audio signals to the changeover switch 114c.

By using the reception strengths of the radio-wave signals received by the two radio-wave receivers 113a and 113b, the positional-relationship determiner 114b determines a relative positional relationship between the two speakers 110 and 120, as described below.

The positional-relationship determiner 114b compares magnitudes of the reception strengths of the radio-wave signals received by the two radio-wave receivers 113a and 113b.

As described above, when the radio-wave transmitter 122a is located at the left side viewed from the two radio-wave receivers 113a and 113b, the reception strength at the right side is smaller than the reception strength at the left side. That is, when the first speaker unit 110 is located at the right side facing the user and the second speaker unit 120 is located at the left side facing the user, the reception strength at the right side is smaller than the reception strength at the left side.

Conversely, when the radio-wave transmitter 122a is located at the right side viewed from the two radio-wave receivers 113a and 113b, the reception strength at the right side is greater than the reception strength at the left side. That is, when the first speaker unit 110 is located at the left side facing the user and the second speaker unit 120 is located at the right side facing the user, the reception strength at the right side is greater than the reception strength at the left side.

In the second embodiment, a memory (not illustrated) stores a table in which the two types of magnitude relationship between the reception strengths and the two types of relative positional relationship between the speaker units are associated with each other on a one-to-one basis. In the table, the magnitude relationship of the reception strength at the right side being smaller than the reception strength at the left side is associated with the positional relationship indicating that the first speaker unit 110 is at the right side and the second speaker unit 120 is at the left side. In the table, the magnitude relationship of the reception strength at the right side being greater than the reception strength at the left side is associated with the positional relationship indicating that the first speaker unit 110 is at the left side and the second speaker unit 120 is at the right side.

By referring to the above-described table, the positional-relationship determiner 114b determines the relative positional relationship between the speaker units on the basis of the magnitude relationship obtained by the reception-strength magnitude comparison. On the basis of the determined positional relationship, the positional-relationship determiner 114b generates a switch control signal. The switch control signal acts as a signal for switching between two switches (described below) in the changeover switch 114c. The positional-relationship determiner 114b sends the generated switch control signal to the changeover switch 114c. The positional-relationship determiner 114b in the second embodiment is one example of the placement determiner that determines the placement of the processing apparatuses on the basis of the wireless-signal detection performed by the sensor. The positional-relationship determiner 114b is one example of the placement determiner that determines the placement of the plurality of speaker units on the basis of the wireless-signal detection performed by the sensor.

In accordance with the switch control signal from the positional-relationship determiner 114b, the changeover switch 114c switches between the two switches (described below) to thereby distribute each of the R-side audio signal and the L-side audio signal as one of a signal for the left speaker unit and a signal for the right speaker unit.

The changeover switch 114c has two input terminals, i.e., an input terminal 114c_R for the R-side audio signal and an input terminal 114c_L for the L-side audio signal. The input terminals 114c_L and 114c_R are coupled to the audio-signal input unit 114a.

In addition, the changeover switch 114c has two output terminals, i.e., an output terminal 114c_1 for the signal (the first audio signal) for the first speaker unit 110 and an output terminal 114c_2 for the signal (the second audio signal) for the second speaker unit 120. The output terminals 114c_1 and 114c_2 are coupled to the amplifying unit 112.

The changeover switch 114c has two switches as described below.

One of the switches is a R-side switch 114c_sR that switchably connects the input terminal 114c_R for the R-side audio signal to the output terminal 114c_1 for the first audio signal and the output terminal 114c_2 for the second audio signal. The other switch is a L-side switch 114c_sL that switchably connects the input terminal 114c_L for the L-side audio signal to the output terminal 114c_1 for the first audio signal and the output terminal 114c_2 for the second audio signal.

The switch control signal generated by the positional-relationship determiner 114b and sent to the changeover switch 114c is a signal based on the positional relationship determined by the positional-relationship determiner 114b.

More specifically, the switch control signal based on the positional relationship indicating that the first speaker unit 110 is at the left side and the second speaker unit 120 is at the right side is a signal for connecting the R-side switch 114c_sR to the output terminal 114c_2 for the second audio signal and connecting the L-side switch 114c_sL to the output terminal 114c_1 for the first audio signal.

Further, the switch control signal based on the positional relationship indicating that the first speaker unit 110 is at the right side and the second speaker unit 120 is at the left side is a signal for connecting the R-side switch 114c_sR to the output terminal 114c_1 for the first audio signal and connecting the L-side switch 114c_sL to the output terminal 114c_2 for the second audio signal.

In the switchover switch 114c, the R-side switch 114c_sR and the L-side switch 114c_sL are switched by the switch control signal described above. Consequently, the R-side audio signal and the L-side audio signal are distributed as signals for the right and left speaker units.

In the example of FIG. 8, on the basis of the example of FIG. 7, the R-side audio signal is distributed as a signal (a first audio signal) for the first speaker unit 110 at the right side facing the user. The L-side audio signal is also distributed as a signal (a second audio signal) for the second speaker unit 120 at the left side facing the user.

In the second embodiment, the positional-relationship determiner 114b and the changeover switch 114c are one example of the signal distributor that sorts and sends signals to corresponding processing apparatuses. The positional-relationship determiner 114b and the changeover switch 114c are one example of the audio-signal distributor that sorts and sends audio signals to the corresponding speakers in the speaker units.

The first and second audio signals distributed to the first and second speaker units 110 and 120 by the changeover switch 114c are sent to the amplifying unit 112.

As illustrated in FIG. 6, the amplifying unit 112 amplifies the two audio signals and inputs the amplified first audio signal to the first speaker 111. The amplifying unit 112 also inputs the amplified second audio signal to the second speaker 121 in the second speaker unit 120 through the second connection cable 133.

As illustrated in FIG. 6, the power supply unit 115 provided in the first speaker unit 110 supplies power to the above-described elements in the first speaker unit 110 and the radio-wave transmitting substrate 122 in the second speaker unit 120. For the supply of the power, the power supply unit 115 performs power conversion processing on the power input from the power source 131. Examples of the power conversion processing involve converting, when the input power is commercial AC power, the AC power into DC power having a magnitude that can be used by the above-described elements. The power supply unit 115 supplies the power, obtained by such power conversion processing, to the above-described elements. The supply of the power from the power supply unit 115 to the radio-wave transmitting substrate 122 in the second speaker unit 120 is also performed through the second connection cable 133, in the same manner as the inputting of the second audio signal to the second speaker 121.

The sound output processing performed by the speaker system 100 of the second embodiment described above with reference to FIGS. 4 to 8 will now be described with reference to a flowchart.

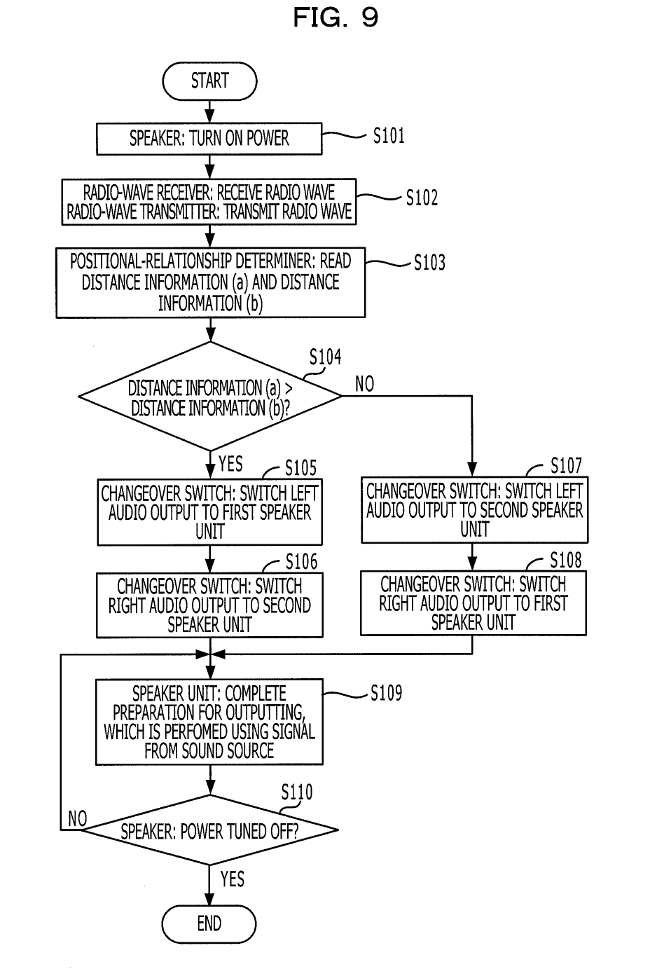

FIG. 9 is a flowchart illustrating the sound output processing performed by the speaker system illustrated in FIGS. 4 to 8. The sound output processing illustrated in the flowchart is performed when the user listens to sound produced by the speaker system 100 of the second embodiment. In the sound output processing, first, in operation S101, the user turns on a power switch (not illustrated) provided at the first speaker unit 110.

When the power switch is turned on, the power supply unit 115 in the first speaker unit 110 supplies power to the individual elements in the first speaker unit 110 and the radio-wave transmitting substrate 122 in the second speaker unit 120. After the power supply is started, the process proceeds to operation S102 in which radio-wave signals are transmitted/received between the radio-wave receiving substrate 113 in the first speaker unit 110 and the radio-wave transmitting substrate 122 in the second speaker unit 120 for a predetermined amount of time, as described below.

That is, in operation S102, the radio-wave transmitter 122a included in the radio-wave transmitting substrate 122 in the second speaker unit 120 transmits a radio-wave signal with a predetermined strength for a predetermined amount of time. The transmitted radio-wave signal is received by the radio-wave receivers 113a and 113b included in the radio-wave receiving substrate 113 in the first speaker unit 110.

As described above, the signal strength of the radio-wave signal transmitted by the radio-wave transmitter 122a in the second speaker unit 120 decreases as the distance from the radio-wave transmitter 122a increases. That is, the radio-wave signal carries, as the signal strength, distance information indicating the distance from the radio-wave transmitter 122a.

In operation S103, the positional-relationship determiner 114b in the first speaker unit 110 reads, as distance information indicating the distances from the radio-wave transmitter 122a to the radio-wave receivers 113a and 113b, the reception strengths of the radio-wave signals received by the radio-wave receivers 113a and 113b.

In operation S104, the positional-relationship determiner 114b determines whether or not the reception strength of the radio-wave signal received by the radio-wave receiver 113a at the right side facing the user is greater than the reception strength of the radio-wave signal received by the radio-wave receiver 113b at the left side facing the user.

When the reception strength at the right side is greater than the reception strength at the left side (Yes in operation S104), the positional-relationship determiner 114b uses the magnitude relationship to refer to the above-described table. As a result, the positional relationship indicating that the first speaker unit 110 is at the left side and the second speaker unit 120 is at the right side is obtained as the relative positional relationship between the speaker units.

On the basis of the positional relationship, the positional-relationship determiner 114b generates a switch control signal for connecting the R-side switch 114c_sR illustrated in FIG. 8 to the output terminal 114c_2 for the second audio signal and connecting the L-side switch 114c_sL to the output terminal 114c_1 for the first audio signal. The positional-relationship determiner 114b sends the generated switch control signal to the changeover switch 114c.

In accordance with the switch control signal, the L-side switch 114c_sL is connected to the output terminal 114c_1 for the first audio signal in operation S105 and the R-side switch 114c_sR is connected to the output terminal 114c_2 for the second audio signal in operation S106.

As a result of the processing described above, a preparation for distributing the L-side audio signal as the audio signal (the first audio signal) for the first speaker unit 110 and distributing the R-side audio signal as the audio signal (the second audio signal) for the second speaker unit 120 is completed.

When the reception strength at the right side is smaller than the reception strength at the left side (No in operation S104), the positional-relationship determiner 114b uses the magnitude relationship to refer to the above-described table. As a result, the positional relationship indicating that the first speaker unit 110 is at the right side and the second speaker unit 120 is at the left side is obtained as the relative positional relationship between the speaker units.

On the basis of the positional relationship, the positional-relationship determiner 114b generates a switch control signal. This switch control signal connects the R-side switch 114c_sR illustrated in FIG. 8 to the output terminal 114c_1 for the first audio signal and connects the L-side switch 114c_sL to the output terminal 114c_2 for the second audio signal. The positional-relationship determiner 114b sends the switch control signal to the changeover switch 114c.

In accordance with the switch control signal, the L-side switch 114c_sL is connected to the output terminal 114c_2 for the second audio signal in operation S107 and the R-side switch 114c_sR is connected to the output terminal 114c_1 for the first audio signal in operation S108.

As a result of the processing described above, a preparation for distributing the L-side audio signal as the audio signal (the second audio signal) for the second speaker unit 120 and distributing the R-side audio signal as the audio signal (the first audio signal) for the first speaker unit 110 is completed.

When the preparation for the distributing is completed through operations S105 and S106 or operations S107 and S108, the process proceeds to operation S109 in which the output-channel switching controller 114 issues a notification indicating the completion of the above-described preparation to the sound-source apparatus 150.

After the issuance of the notification, the L-side audio signal and R-side audio signal sent from the sound-source apparatus 150 are appropriately distributed by the changeover switch 114c for which the preparation has been completed as described above, the distributed audio signals are amplified by the amplifying unit 112, and the amplified audio signals are input to the corresponding speakers 111 and 121.

The audio-signal inputting to the speakers in operation S109 is continuously performed while the power switch (not illustrated) of the first speaker unit 110 is on (i.e., No in operation S110). When the power switch of the first speaker unit 110 is turned off (i.e., Yes in operation S110), the sound output processing illustrated in the flowchart of FIG. 9 ends.

As described above, in the speaker system 100 of the second embodiment, the R-side audio signal is distributed to the speaker in the speaker unit actually placed at the right side and the L-side audio signal is distributed to the speaker in the speaker unit actually placed at the left side. As a result, no matter how the two speakers 110 and 120 are placed, sound represented by the R-side audio signal is heard from the right side and sound represented by the L-side audio signal is heard from the left side.

Thus, no matter in what positional relationship the user places the two speaker units 110 and 120, the speaker system 100 produces sound that does not give an odd sensation. That is, the speaker system 100 has a high degree of freedom in the placement of the speaker units.

In the second embodiment, the reception strengths of the radio-wave signals received by the radio-wave receivers 113a and 113b are used to determine the relative positional relationship between the two speaker units 110 and 120. In general, the signal strength of a radio-wave signal transmitted from an transmitting source decreases as the distance from the transmitting source increases. That is, the radio-wave signal carries, as the signal strength, distance information indicating the distance from the transmitting source.

In the second embodiment, the property of the radio-wave signal is utilized to determine the position of the radio-wave transmitter 122a relative to the two radio-wave receivers 113a and 113b. With this arrangement, the relative positional relationship between the speaker units can be reliably determined.

This means that an applied form as described below is preferably applicable to the speaker system of the present disclosure. In one applied form, each of the above-described speaker units has the transmitter and at least one sensor of the set of sensors placed at respective different positions. In the applied form, the placement determiner described above utilizes the detection strength of the wireless signal of each sensor belonging to the set of sensors. The placement determiner determines the position of the transmitter relative to the set of sensors to thereby determine the placement of the speaker units.

The speaker units 110 and 120 in the second embodiment are one example of the speaker units in the applied form. The set of two radio-wave receivers 113a and 113b in the second embodiment is one example of the set of sensors in this applied form. The positional-relationship determiner 114b in the second embodiment is one example of the placement determiner in the applied form.

In the second embodiment, on the basis of the result of the magnitude comparison of the reception strengths of the radio-wave receivers 113a and 113b, the positional-relationship determiner 114b determines the position of the radio-wave transmitter 122a relative to the radio-wave receivers 113a and 113b. In the second embodiment comparing the magnitudes of the reception strengths is used to determine the relative position.

This means that, in the above-described applied form for determining the placement of the speaker units by using the detection strengths at the sensors, an applied form below is further preferable.

In the applied form, the placement determiner determines the position of the transmitter relative to the set of sensors on the basis of the magnitude comparison of the detection strengths of the wireless signals detected by the set of sensors.

The positional-relationship determiner 114b in the second embodiment is one example of the placement determiner in the applied form.

Next, a description will be given of a signal processing system and a speaker system according to a third embodiment of the present disclosure.

In the third embodiment, a method for determining the placement of the speaker units is different from the method in the second embodiment. With attention being paid to the difference point, the third embodiment will be described below.

In the third embodiment, a speaker system including a plurality of speaker units is exemplified as one embodiment of the signal processing system including the plurality of processing apparatuses that receive signals and execute processing on the signals, as in the first embodiment described above. In the third embodiment, for simplicity of description, a speaker system including two speaker units 210 and 220 is exemplified as in the above-described comparative example and the second embodiment.

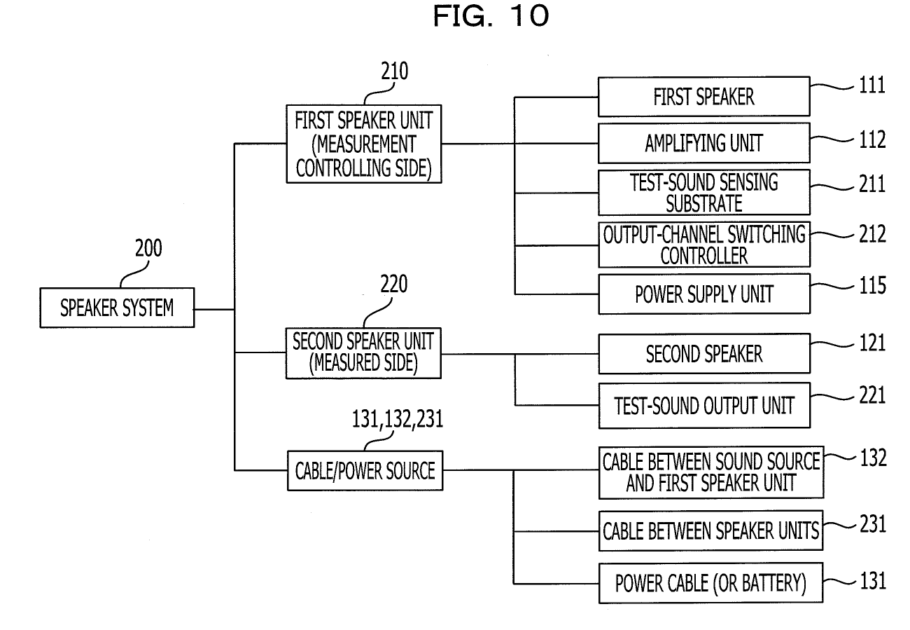

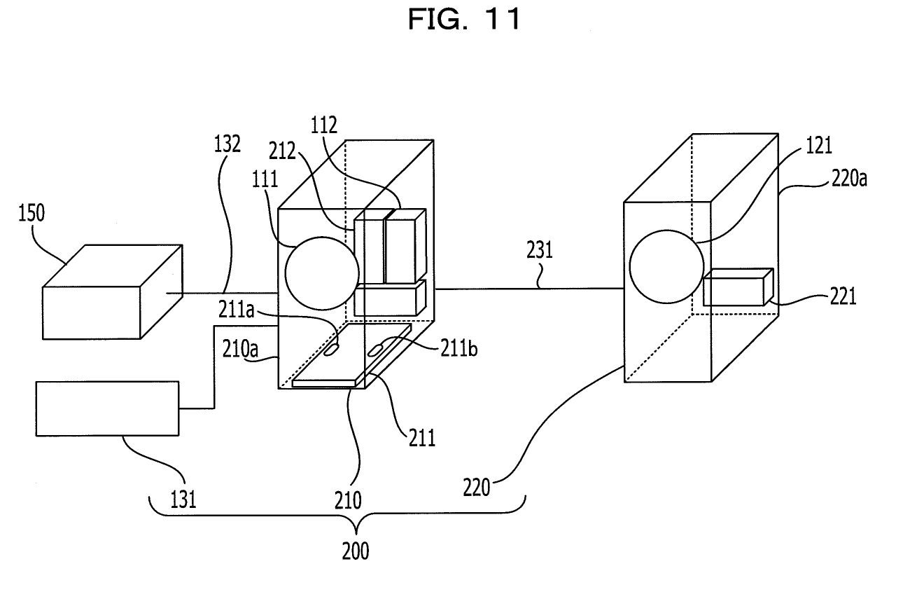

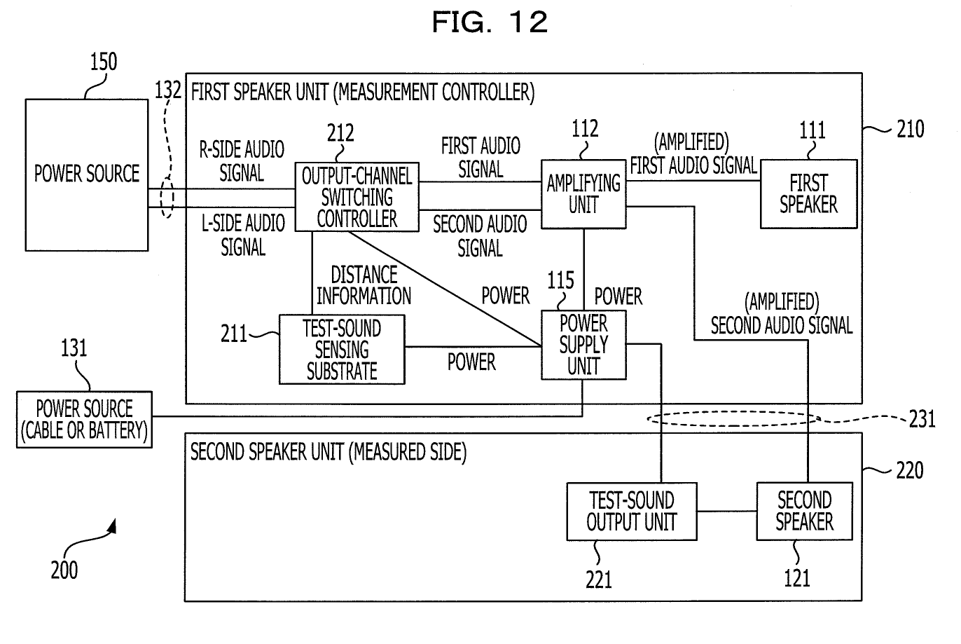

FIG. 10 is a hierarchical diagram illustrating the third embodiment of the signal processing system and the speaker system. FIG. 11 is a schematic view of the speaker system illustrated in FIG. 10. FIG. 12 is a block diagram illustrating the speaker system illustrated in FIGS. 10 and 11.

In FIGS. 10 to 12, elements that are equivalent to those illustrated in FIGS. 4 to 6 are denoted by the same reference numerals as those in FIGS. 4 to 6. Descriptions of those equivalent elements are not given hereinafter.

A speaker system 200 illustrated in FIGS. 10 to 12 is also of a type in which a first speaker unit 210 and a second speaker unit 220 are placed at the right and left sides, as in the second embodiment described above. The first speaker unit 210 includes a first speaker 111 and the second speaker unit 220 includes a second speaker 121.

In the third embodiment, expressions “right side” and “left side” in the system also refer to the right side and the left side, respectively, when the user is viewed from the speaker units facing the user, as described above with reference to FIG. 1.

Each of the first and second speaker units 210 and 220 in the third embodiment is one example of a processing apparatus that receives a signal and executes processing on the signal.

Each of the first and second speaker units 210 and 220 is one example of a speaker unit that receives an audio signal representing sound and that includes a speaker for transmitting the sound represented by the audio signal. In the third embodiment, each of the number of processing apparatuses and the number of speaker units is two, which is one example of a plurality, as in the second embodiment described above.

In the third embodiment, the second speaker unit 220 includes a test-sound output unit 221, which generates an audio signal representing test sound (described above) and inputs the audio signal to the second speaker 121. Power is supplied from a power supply unit 115 to the test-sound output unit 221 through a second connection cable 231 that interconnects the two speakers 210 and 220.

In the third embodiment, the first speaker unit 210 includes a test-sound sensing substrate 211, which detects test sound produced by the second speaker 121. On the basis of a result of the detection performed by the test-sound sensing substrate 211, an output-channel switching controller 212 in the third embodiment distributes two audio signals to the two speakers 111 and 121. The sorted audio signals are amplified by an amplifying unit 112. The audio signal distributed to the first speaker 111 is directly input thereto and the audio signal distributed to the second speaker 121 is input thereto through the second connection cable 231.

The test-sound sensing substrate 211 is provided with two microphones 211a and 211b. As schematically illustrated in FIG. 11, the test-sound sensing substrate 211 is provided in a housing 210a of the first speaker unit 210. More specifically, the test-sound sensing substrate 211 is provided at substantially the center of a bottom plate of the housing 210a of the first speaker unit 210. The test-sound sensing substrate 211 is positioned in the first speaker unit 210 so that the two microphones 211a and 211b are arranged at the right and left sides.

A description will be given of how the test sound produced by the second speaker 121 provided in a housing 220a of the second speaker unit 220 is detected by the two microphones 211a and 211b of the first speaker unit 210 in the third embodiment.

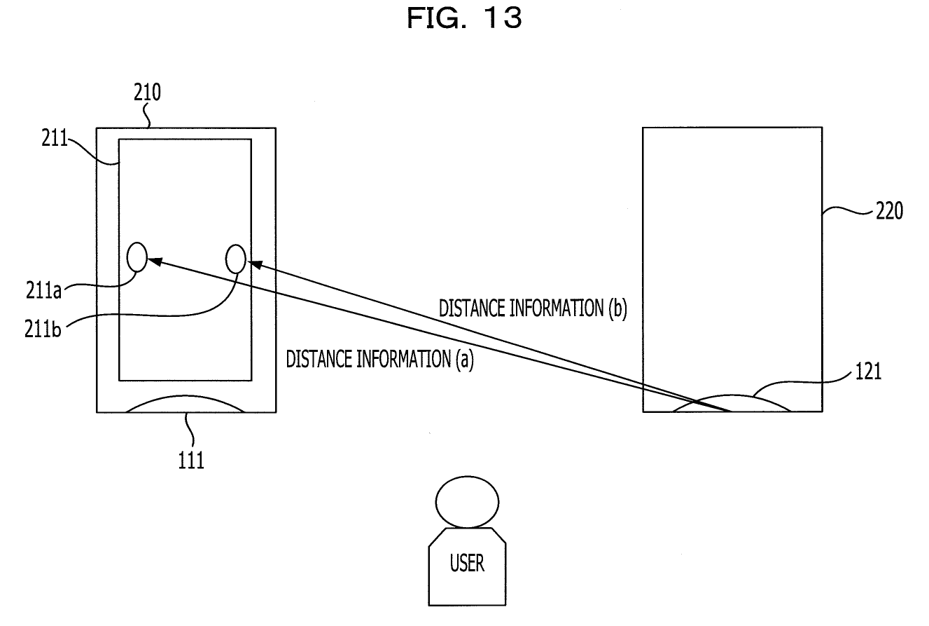

FIG. 13 schematically illustrates a state in which the test sound produced by the second speaker in the second speaker unit is detected by two microphones of the first speaker unit.

When power is supplied from the power supply unit 115 in the first speaker unit 210 to the second speaker unit 220, the test-sound output unit 221 generates an audio signal representing test sound having a predetermined sound level for a predetermined amount of time from the point of time of the power supply and inputs the generated audio signal to the second speaker 121. As a result, the second speaker 121 produces the test sound having the predetermined sound level for the predetermined amount of time from the point of time the power supply is started. The sound level of the test sound produced by the second speaker 121 decreases, as the distance from the second speaker 121 increases. That is, the test sound carries, as the sound level, distance information indicating the distance from the second speaker 121. The test sound is detected by the two microphones 211a and 211b provided on the test-sound sensing substrate 211 in the first speaker unit 210.

The second speaker 121 in the third embodiment is one example of a transmitter that transmits a wireless signal. Each of the microphones 211a and 211b in the third embodiment is one example of the sensor that detects the wireless signal transmitted by the transmitter. In the third embodiment, the test sound produced by the second speaker 121 and detected by the two microphones 211a and 211b is one example of the wireless signal.

As described above, the test-sound sensing substrate 211 is provided in the housing 210a so that the two microphones 211a and 211b are arranged at the right and left sides.

In the example of FIG. 13, the second speaker unit 220 is placed at the left side of the first speaker unit 210 toward the user. That is, the second speaker 121 in the second speaker unit 220 is located at the left side of the user, when viewed from the two microphones 211a and 211b arranged at the right and left sides in the first speaker unit 210. As a result, the distance between the microphone 211a at the right side and the second speaker 121 is larger than the distance between the microphone 211b at the left side and the second speaker 121.

As described above, the sound level of the test sound decreases as the distance from the second speaker 121 increases, and thus the test sound carries, as the sound level, distance information indicating the distance from the second speaker 121. Thus, in the example of FIG. 13, the detection strength of the test sound detected by the microphone 211a at the right side facing the user is smaller than the detection strength of the test sound detected by the microphone 211b at the left side facing the user.

A description will now be given of a case in which the second speaker unit 220 is placed at the right side of the first speaker unit 210 toward the user, as opposed to the example of FIG. 13. This arrangement corresponds to a case in which the second speaker 121 is located at the right side of the user, when viewed from the two microphones 211a and 211b. In this case, the distance between the microphone 211a at the right side and the second speaker 121 is smaller than the distance between the microphone 211b at the left side and the second speaker 121.

Thus, in this example, the detection strength of the test sound detected by the microphone 211a at the right side facing the user is greater than the detection strength of the test sound detected by the microphone 211b at the left side facing the user.

By using the detection strengths of the test sound detected by the two microphones 211a and 211b, the output-channel switching controller 114 illustrated in FIGS. 10 to 12 distributes each of the R-side audio signal and the L-side audio signal as a signal for one of the two speakers 111 and 121. How the audio signals are distributed is described below in detail.

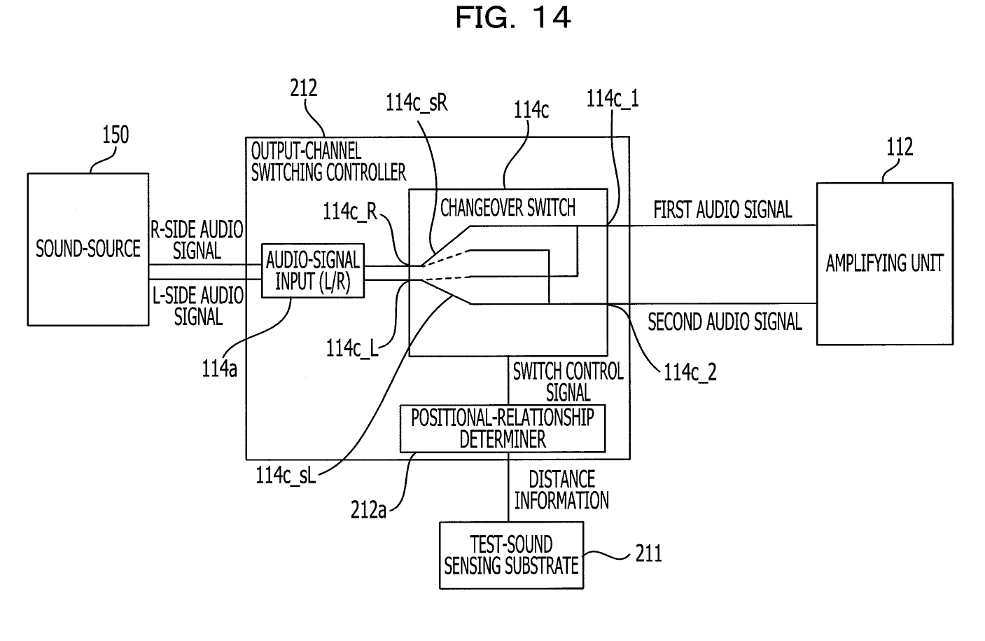

FIG. 14 is a block diagram illustrating details of the output-channel switching controller illustrated in FIGS. 10 to 12. In FIG. 14, elements that are equivalent to those illustrated in FIG. 8 are denoted by the same reference numerals as those in FIG. 8. Descriptions of those equivalent elements are not given hereinafter.

By using the detection strengths of the test sound detected by the two microphones 211a and 211b, a positional-relationship determiner 212a illustrated in FIG. 14 determines a relative positional relationship between the two speakers 210 and 220, as described below.

The positional-relationship determiner 212a compares magnitudes of the detection strengths of the test sound received by the two microphones 211a and 211b.

As described above, when the second speaker 121 is located at the left side viewed from the two microphones 211a and 211b, the detection strength at the right side is smaller than the detection strength at the left side. That is, when the first speaker unit 210 is located at the right side facing the user and the second speaker unit 220 is located at the left side facing the user, the detection strength at the right side is smaller than the detection strength at the left side.

Conversely, when the second speaker 121 is located at the right side viewed from the two microphones 211a and 211b, the detection strength at the right side is greater than the detection strength at the left side. That is, when the first speaker unit 210 is located at the left side facing the user and the second speaker unit 220 is located at the right side facing the user, the reception strength at the right side is greater than the reception strength at the left side.

In the third embodiment, a memory (not illustrated) stores a table in which the two types of magnitude relationship between the detection strengths of the test sound and the two types of relative positional relationship between the speaker units are associated with each other on a one-to-one basis.

In the table, the magnitude relationship of the detection strength at the right side being smaller than the detection strength at the left side is associated with the positional relationship indicating that the first speaker unit 210 is at the right side and the second speaker unit 220 is at the left side. In the table, the magnitude relationship of the detection strength at the right side being greater than the detection strength at the left side is associated with the positional relationship indicating that the first speaker unit 210 is at the left side and the second speaker unit 220 is at the right side.

By using the magnitude relationship obtained by the detection-strength magnitude comparison and referring to the above-described table, the positional-relationship determiner 212a determines the relative positional relationship between the units. On the basis of the determined positional relationship, the positional-relationship determiner 212a generates a switch control signal that is similar to the switch control signal in the second embodiment described above. The positional-relationship determiner 212a sends the generated switch control signal to a changeover switch 114c. The positional-relationship determiner 212a in the third embodiment is one example of the placement determiner that determines the placement of the plurality of processing apparatuses on the basis of the wireless-signal detection performed by the sensor. The positional-relationship determiner 212a is one example of the placement determiner that determines the placement of the plurality of speaker units on the basis of the wireless-signal detection performed by the sensor.

When the changeover switch 114c receives the switch control signal from the positional-relationship determiner 212a, a R-side switch 114c_sR and a L-side switch 114c_sL are switched according to the switch control signal. Consequently, the R-side audio signal and the L-side audio signal are distributed as signals for the right and left speaker units.

In the third embodiment, the positional-relationship determiner 212a and the changeover switch 114c are one example of the signal distributor that sorts and sends signals to the plurality of processing apparatuses. The positional-relationship determiner 212a and the changeover switch 114c are one example of the audio-signal distributor that distributes and sends multiple audio signals to the plurality of speakers in the speaker units.

In the example of FIG. 14, the R-side audio signal is distributed as a signal (a first audio signal) for the first speaker unit 210 at the right side facing the user, on the basis of the example of FIG. 13, and is sent to the amplifying unit 112. The L-side audio signal is also distributed as a signal (a second audio signal) for the second speaker unit 220 at the left side facing the user and is sent to the amplifying unit 112.

As illustrated in FIG. 12, the amplifying unit 112 amplifies the two audio signals and inputs the amplified first audio signal to the first speaker 111. The amplifying unit 112 also inputs the amplified second audio signal to the second speaker 121 in the second speaker unit 220 through the second connection cable 231.

The sound output processing performed by the speaker system 200 of the third embodiment described above with reference to FIGS. 10 to 14 will now be described with reference to a flowchart.

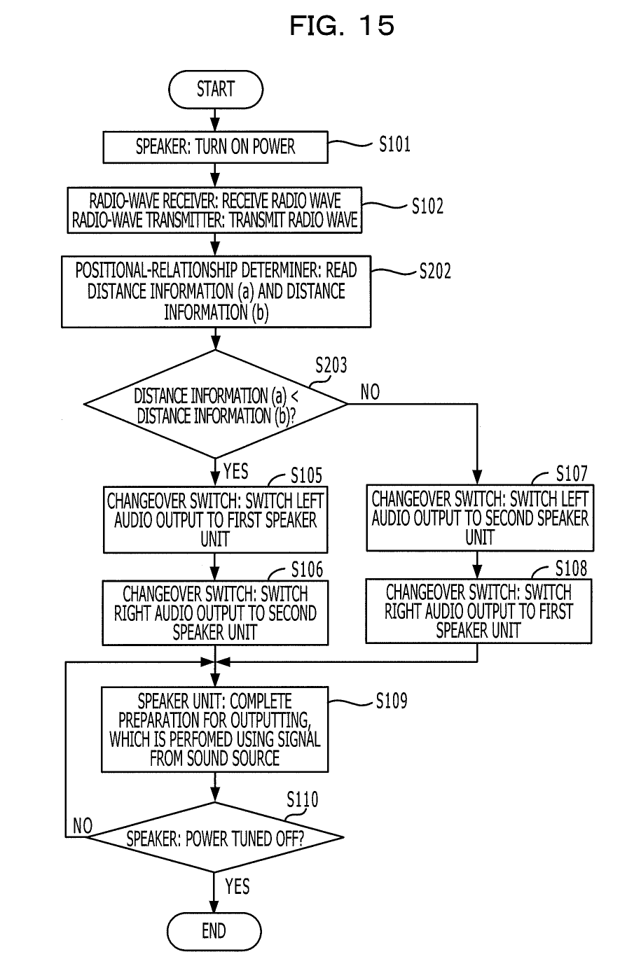

FIG. 15 is a flowchart illustrating the sound output processing performed by the speaker system illustrated in FIGS. 10 to 14. In FIG. 15, processing operations that are equivalent to those illustrated in the flowchart of FIG. 9 are denoted by the same reference characters as those in FIG. 9. Descriptions of those equivalent processing operations are not given hereinafter.

In the sound output processing illustrated in the flowchart, first, when the power switch (not illustrated) of the first speaker unit 210 is turned on in operation S101, power is supplied from the power supply unit 115 to the individual elements. After the power supply is started, the process proceeds to operation S201 in which generation and detection of a test sound as described below are performed for a predetermined amount of time.

That is, in operation S201, the test-sound output unit 221 in the second speaker unit 220 generates an audio signal representing test sound having a predetermined sound level for a predetermined amount of time and inputs the audio signal to the second speaker 121. As a result, the second speaker 121 produces the test sound having the predetermined sound level for the predetermined amount of time from the point of time the power supply is started. The test sound is detected by the two microphones 211a and 211b provided on the test-sound sensing substrate 211 in the first speaker unit 210.

As described above, the sound level of the test sound decreases as the distance from the second speaker 121 increases. That is, the test sound carries, as the sound level, distance information indicating the distance from the second speaker 121.

In operation S202, the positional-relationship determiner 212a reads, as distance information indicating the distances from the second speaker 121 to the microphones 211a and 211b, the detection strengths of the test sound detected by the microphones 211a and 211b.

In operation S203, the positional-relationship determiner 212a determines whether or not the detection strength of the test sound detected by the microphone 211a at the right side facing the user is greater than the detection strength of the test sound detected by the microphone 211b at the left side facing the user.

When the detection strength at the right side is greater than the detection strength at the left side (Yes in operation S203), the positional-relationship determiner 212a uses the magnitude relationship to refer to the above-described table. As a result, the positional relationship indicating that the first speaker unit 210 is at the left side and the second speaker unit 220 is at the right side is obtained as the relative positional relationship between the speaker units.

On the basis of the positional relationship, the positional-relationship determiner 212a generates a switch control signal. This switch control signal connects the R-side switch 114c_sR illustrated in FIG. 14 to the output terminal 114c_2 for the second audio signal and connects the L-side switch 114c_sL to the output terminal 114c_1 for the first audio signal. The positional-relationship determiner 212a sends the switch control signal to the changeover switch 114c.

When the detection strength at the right side is smaller than the detection strength at the left side (No in operation S203), the positional-relationship determiner 212a uses the magnitude relationship to refer to the above-described table. As a result, the positional relationship indicating that the first speaker unit 210 is at the right side and the second speaker unit 220 is at the left side is obtained as the relative positional relationship between the speaker units.

On the basis of the positional relationship, the positional-relationship determiner 212a generates a switch control signal. This switch control signal connects the R-side switch 114c_sR illustrated in FIG. 14 to the output terminal 114c_1 for the first audio signal and connects the L-side switch 114c_sL to the output terminal 114c_2 for the second audio signal. The positional-relationship determiner 212a sends the switch control signal to the changeover switch 114c.

Upon reception of the switch control signal from the positional-relationship determiner 212a, a preparation for distributing is performed in either operations S105 and S106 or operations S107 and S108. Thereafter, in operation S109, a notification indicating completion of the preparation is sent from the output-channel switching controller 212 to the sound-source apparatus 150.

After the issuance of the notification, the L-side audio signal and R-side audio signal sent from the sound-source apparatus 150 are appropriately distributed by the changeover switch 114c for which the preparation has been completed as described above, the distributed audio signals are amplified by the amplifying unit 112, and the amplified audio signals are input to the corresponding speakers 111 and 121.

The audio-signal inputting to the speakers in operation S109 is continuously performed while the power switch (not illustrated) of the first speaker unit 210 is on (i.e., No in operation S110). When the power switch is turned off (i.e., Yes in operation S110), the sound output processing illustrated in the flowchart of FIG. 15 ends.

As described above, the speaker system 200 of the third embodiment also allows the user to arbitrarily place the two speaker units 210 and 220.

In the third embodiment, the test sound produced by the second speaker 121 is used as a wireless signal for determining the placement of the two speaker units 210 and 220. Thus, in the third embodiment, the second speaker 121 also servers as a transmitter of the wireless signal, as described above, thereby reducing the component count.

This means that, in the above-described applied form for determining the placement of the speaker units by using the detection strengths at the two sensors, an applied form below is further preferable. In the applied form, the speaker included in the speaker unit also serves as the transmitter to produce sound represented by the wireless signal. In the applied form, each of the sensors corresponds to the microphone that detects sound.

The second speaker 121 in the third embodiment is one example of the transmitter in the applied form. Each of the two microphones 211a and 211b in the third embodiment is one example of the set of sensors in this applied form.

The two speaker units 210 and 220 in the third embodiment are examples of a plurality of speaker units in the applied form which determine the placement of the speaker units by using the detection strengths of the plurality of sensors. The set of two microphones 211a and 211b in the third embodiment is one example of the set of sensors in this applied form. The positional-relationship determiner 212a in the third embodiment is one example of the placement determiner in the applied form.

In the second and third embodiments described above, a method for determining the placement of the plurality of speaker units on the basis of the magnitude comparison of the detection strengths has been exemplified as a method for determining the placement of the plurality of speaker units by using the detection strengths at the plurality of sensors. However, the method for determining the placement of the plurality of speaker units by using the detection strengths at the plurality of sensors is not limited to the above-described method. A method for determining the position of the transmitter relative to two sensors by using the so-called “triangulation” utilizing detection strengths at the two sensors may also be used to determine the placement of the plurality of speaker units.

Next, a description will be given of a fourth embodiment of a speaker system according to the present disclosure.

A method for determining the placement of the speaker units in the fourth embodiment is different from those of the second and third embodiments described below. With attention being paid to the difference point, the fourth embodiment will be described below.

In the fourth embodiment, a speaker system including a plurality of speaker units is exemplified as one embodiment of the signal processing system including the plurality of processing apparatuses that receive signals and execute processing on the signals, as in the first to third embodiments described above. In the fourth embodiment, for simplicity of description, a speaker system including two speaker units is exemplified as in the above-described comparative example and the second and third embodiments.

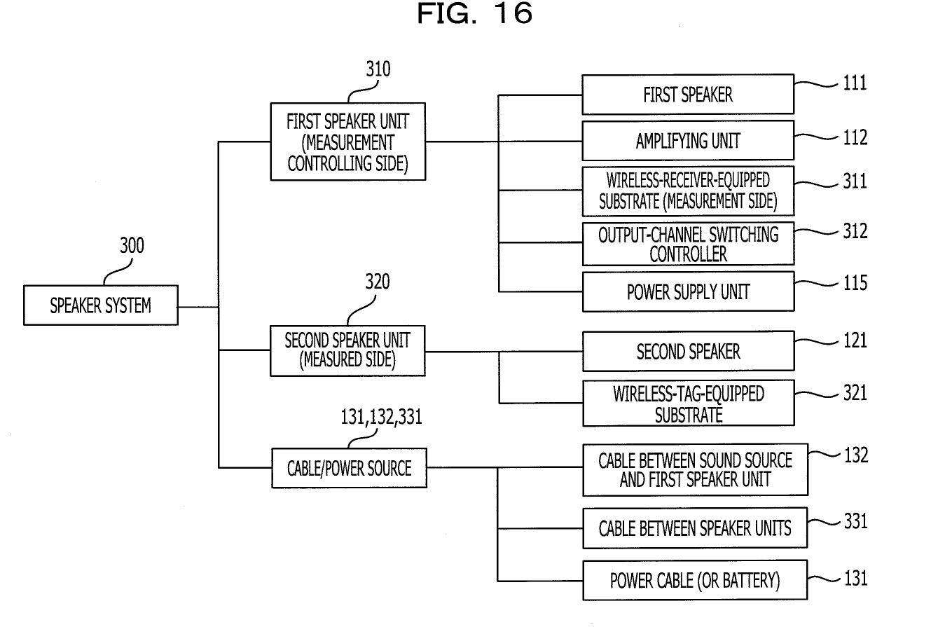

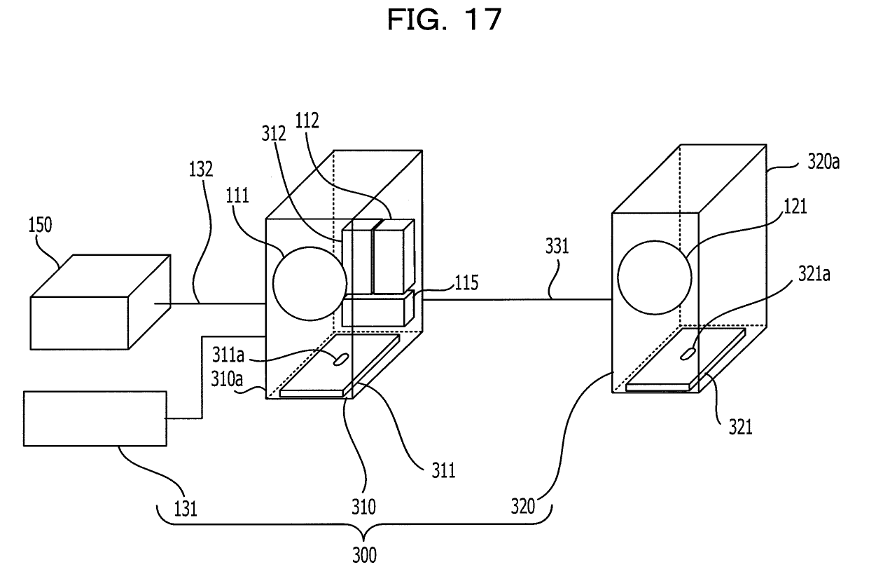

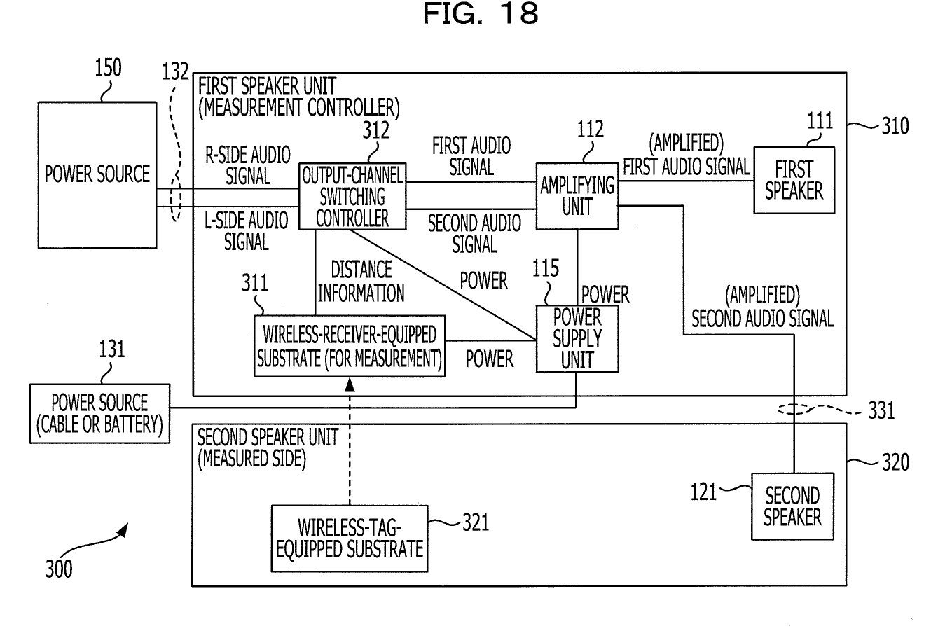

FIG. 16 is a hierarchical diagram illustrating the fourth embodiment of the signal processing system and the speaker system. FIG. 17 is a schematic view of the speaker system illustrated in FIG. 16. FIG. 18 is a block diagram illustrating the speaker system illustrated in FIGS. 16 and 17.

In FIGS. 16 to 18, elements that are equivalent to those illustrated in FIGS. 4 to 6 are denoted by the same reference numerals as those in FIGS. 4 to 6. Descriptions of those equivalent elements are not given hereinafter.

A speaker system 300 illustrated in FIGS. 16 to 18 is also of a type in which a first speaker unit and a second speaker unit are placed at the right and left sides, as in the second embodiment described above. A first speaker unit 310 includes a first speaker 111 and a second speaker unit 320 includes a second speaker 121.

In the fourth embodiment, expressions “right side” and “left side” in the system also refer to the right side and the left side, respectively, when the user is viewed from the speaker units facing the user, as described above with reference to FIG. 1.

Each of the first and second speaker units in the fourth embodiment is one example of the processing apparatus that receives a signal and executes processing on the signal.

Each of the first and second speaker units is one example of a speaker unit that receives an audio signal representing sound and that includes a speaker for transmitting the sound represented by the audio signal. In the fourth embodiment, each of the number of processing apparatuses and the number of speaker units is two, which is one example of a plurality, as in the second and third embodiments described above.

In the fourth embodiment, the second speaker unit 320 includes a wireless-tag-equipped substrate 321, which is equipped with a wireless tag 321a that transmits a directional radio-wave signal. The first speaker unit 310 includes a wireless-receiver-equipped substrate 311, which is equipped with a wireless receiver 311a for receiving the aforementioned directional radio-wave signal.

Power is supplied from a power supply unit 115 in the first speaker unit 310 to the wireless receiver 311a. In turn, a request signal for requesting transmission of the directional radio-wave signal is transmitted from the wireless tag 321a to the wireless receiver 311a. Power needed to transmit the directional radio-wave signal is supplied to the wireless tag 321a over the request signal.

The wireless tag 321a in the fourth embodiment is one example of the transmitter that transmits a wireless signal. The wireless receiver 311a in the fourth embodiment is one example of the sensor that detects the wireless signal transmitted by the transmitter. In the fourth embodiment, the directional radio-wave signal is one example of the wireless signal.

In the fourth embodiment, the wireless tag 321a of the second speaker unit 320 and the wireless receiver 311a of the first speaker unit 310 perform operations as described below, to determine the placement of the two speakers 310 and 320.

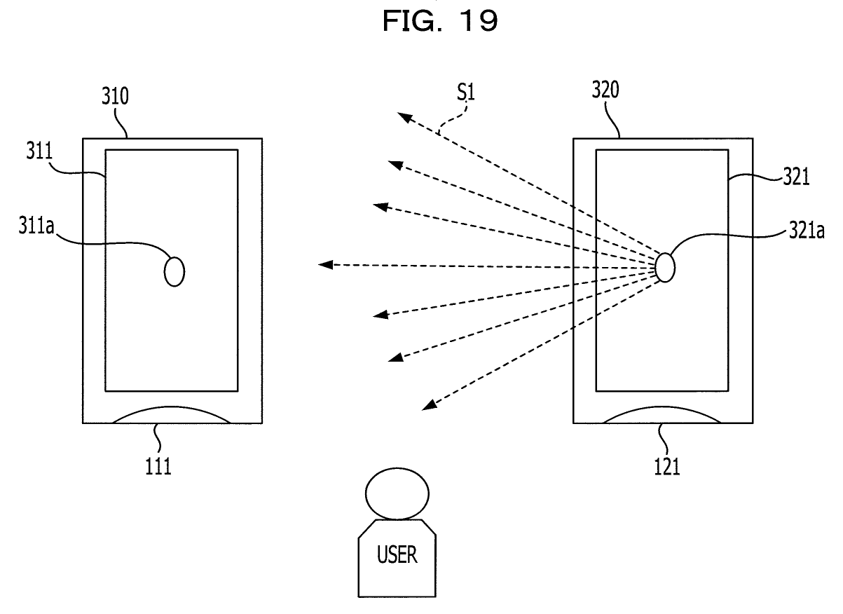

FIG. 19 schematically illustrates an operation performed by the wireless tag of the second speaker unit and the wireless receiver of the first speaker unit.

The wireless-receiver-equipped substrate 311 is provided in the first speaker unit 310, as schematically illustrated in FIGS. 17 and 19. The wireless-receiver-equipped substrate 311 is provided in a housing 310a so that the wireless receiver 311a is positioned at substantially the center of a bottom plate of the housing 310a. The wireless-tag-equipped substrate 321 is provided in the second speaker unit 320. The wireless-tag-equipped substrate 321 is provided in a housing 320a so that the wireless tag 321a is positioned at substantially the center of a bottom plate of the housing 320a. In the fourth embodiment, the wireless-tag-equipped substrate 321 is positioned in the housing 320a so that the directivity of a directional radio-wave signal S1 is directed toward the right side of the second speaker unit 320 so as to face the user.

In the example of FIG. 19, the second speaker unit 320 is placed at the left side of the first speaker unit 310 so as to face the user. That is, the wireless tag 321a in the second speaker unit 320 is located at the left side of the user, when viewed from the wireless receiver 311a of the first speaker unit 310. As a result, the directional radio-wave signal S1 transmitted by the wireless tag 321a travels toward the wireless receiver 311a and is thus received by the wireless receiver 311a without any problem.

A description will now be given of a case in which the second speaker unit 320 is placed at the left side of the first speaker unit 310 toward the user, as opposed to the example of FIG. 19. This arrangement corresponds to a case in which the wireless tag 321a is located at the right side of the user, when viewed from the wireless receiver 311a. In this case, the directional radio-wave signal S1 transmitted by the wireless tag 321a travels in a direction opposite to the direction of the wireless receiver 311a. Thus, the directional radio-wave signal S1 is not received by the wireless receiver 311a.

On the basis of whether or not the directional radio-wave signal has been received by the wireless receiver 311a, the output-channel switching controller 312 illustrated in FIGS. 16 to 18 distributes each of the R-side audio signal and the L-side audio signal as a signal for one of the two speakers 111 and 121. How the audio signals are distributed is described below in detail.

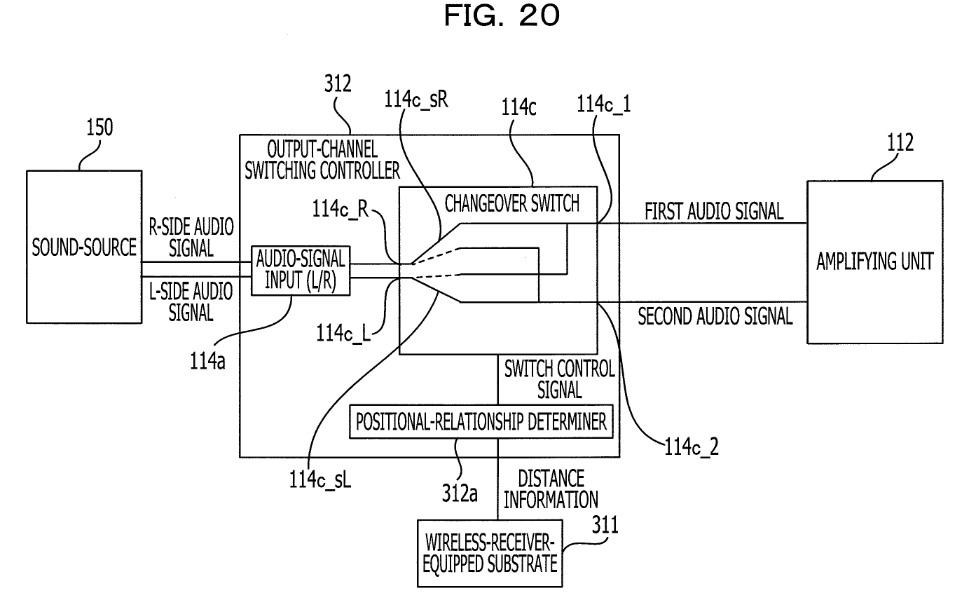

FIG. 20 is a block diagram illustrating details of the output-channel switching controller illustrated in FIGS. 16 to 18. In FIG. 20, elements that are equivalent to those illustrated in FIG. 8 are denoted by the same reference numerals as those in FIG. 8. Descriptions of those equivalent elements are not given hereinafter.

A positional-relation determiner 312a illustrated in FIG. 20 determines the positional relationship between two speaker units 310 and 320, on the basis of whether or not the wireless receiver 311a receives the directional radio-wave signal, as described below.

As described above with reference to FIG. 19, when the wireless tag 321a is placed at the left side viewed from the wireless receiver 311a, the wireless receiver 311a receives the directional radio-wave signal. Conversely, when the wireless tag 321a is placed at the right side viewed from the wireless receiver 311a, the wireless receiver 311a does not receive the directional radio-wave signal.

In the fourth embodiment, a memory (not illustrated) stores a table in which reception statuses indicating whether or not the wireless receiver 311a has received the signal and the above-described two types of relative positional relationships between the speaker units are associated with each other on a one-to-one basis.

In the table, the reception status indicating that the wireless receiver 311a has detected the signal is associated with the positional relationship indicating that the first speaker unit 310 is at the right side and the second speaker unit 320 is at the left side. The reception status indicating that the wireless receiver 311a has not detected the signal is associated with the positional relationship indicating that the first speaker unit 310 is at the left side and the second speaker unit 320 is at the right side.

By using the reception status of the wireless receiver 311a at a predetermined timing and referring to the above-described table, the positional-relationship determiner 312a determines the relative positional relationship between the units. On the basis of the determined positional relationship, the positional-relationship determiner 312a generates a switch control signal that is similar to the switch control signal in the second embodiment described above. The positional-relationship determiner 312a sends the generated switch control signal to a changeover switch 114c. The positional-relationship determiner 312a in the fourth embodiment is one example of the placement determiner that determines the placement of the plurality of processing apparatuses on the basis of the wireless-signal detection performed by the sensor. The positional-relationship determiner 312a is one example of the placement determiner that determines the placement of the plurality of speaker units on the basis of the wireless-signal detection performed by the sensor.

When the changeover switch 114c receives the switch control signal from the positional-relationship determiner 312a, a R-side switch 114c_sR and a L-side switch 114c_sL are switched according to the switch control signal. Consequently, the R-side audio signal and the L-side audio signal are distributed as signals for the right and left speaker units.

In the fourth embodiment, the positional-relationship determiner 312a and the changeover switch 114c are one example of the signal distributor that sorts and sends signals to the plurality of processing apparatuses. The positional-relationship determiner 312a and the changeover switch 114c are one example of the audio-signal distributor that sorts and sends audio signals to the plurality of speakers in the speaker units.

In the example of FIG. 20, the R-side audio signal is distributed as a signal (a first audio signal) for the first speaker unit 310 at the right side facing the user, on the basis of the example of FIG. 19, and is sent to the amplifying unit 112. The L-side audio signal is also distributed as a signal (a second audio signal) for the second speaker unit 320 at the left side facing the user and is sent to the amplifying unit 112.

The amplifying unit 112 then amplifies the two audio signals and inputs the amplified first audio signal to the first speaker 111, as illustrated in FIG. 18. The amplifying unit 112 also inputs the amplified second audio signal to the second speaker 121 in the second speaker unit 320 through the second connection cable 231.

The sound output processing performed by the speaker system 300 of the fourth embodiment described above with reference to FIGS. 16 to 20 will now be described with reference to a flowchart.

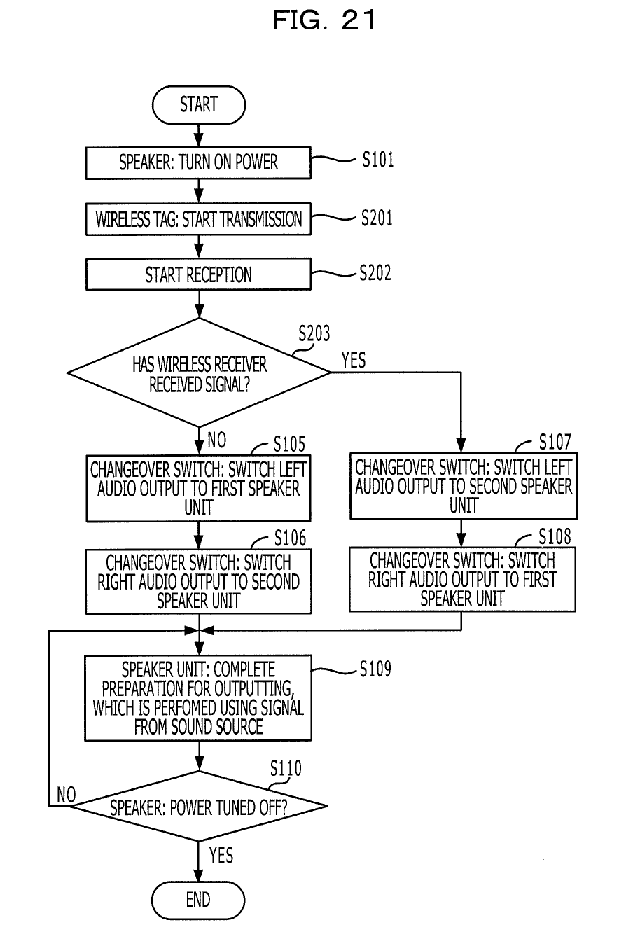

FIG. 21 is a flowchart illustrating the sound output processing performed by the speaker system illustrated in FIGS. 16 to 20. In FIG. 21, processing operations that are equivalent to those illustrated in the flowchart of FIG. 9 are denoted by the same reference characters as those in FIG. 9. Descriptions of those equivalent processing operations are not given hereinafter.

In the sound output processing illustrated in the flowchart, first, when the power switch (not illustrated) of the first speaker unit 110 is turned on in operation S101, power is supplied from the power supply unit 115 to the individual elements.

After the power supply is started, a request signal for requesting transmission of a directional radio-wave signal is transmitted from the wireless receiver 311a to the wireless tag 321a, with power for operating the wireless tag 321a being supplied over the request signal. In operation S201, in response to the request signal, the wireless tag 321a transmits the directional radio-wave signal by using the power supplied over the request signal. After the transmission of the request signal, in operation S202, the wireless receiver 311a is put into a state for waiting for the directional radio-wave signal to be transmitted.

Next, in operation S203, the positional-relationship determiner 312a determines whether or not the wireless receiver 311a has received the directional radio-wave signal in a predetermined amount of time.

When the wireless receiver 311a has not received the directional radio-wave signal (No in operation S203), the positional-relationship determiner 312a refers to the above-described table by using the status indicating that the directional radio-wave signal has not been received. As a result, the positional relationship indicating that the first speaker unit 310 is at the left side and the second speaker unit 320 is at the right side is obtained as the relative positional relationship between the speaker units.

On the basis of the positional relationship, the positional-relationship determiner 312a generates a switch control signal. This switch control signal connects the R-side switch 114c_sR illustrated in FIG. 20 to the output terminal 114c_2 for the second audio signal and connects the L-side switch 114c_sL to the output terminal 114c_1 for the first audio signal. The positional-relationship determiner 312a sends the switch control signal to the changeover switch 114c.

Conversely, when the directional radio-wave signal is received by the wireless receiver 311a (Yes in operation S203), the positional-relationship determiner 312a refers to the above-described table by using the status indicating that the directional radio-wave signal is received. As a result, the positional relationship indicating that the first speaker unit 310 is at the right side and the second speaker unit 320 is at the left side is obtained as the relative positional relationship between the speaker units.

On the basis of the positional relationship, the positional-relationship determiner 312a generates a switch control signal. This switch control signal connects the R-side switch 114c_sR illustrated in FIG. 20 to the output terminal 114c_1 for the first audio signal and connects the L-side switch 114c_sL to the output terminal 114c_2 for the second audio signal. The positional-relationship determiner 312a sends the switch control signal to the changeover switch 114c.

Upon reception of the switch control signal from the positional-relationship determiner 312a, a preparation for distributing is performed in either operations S105 and S106 or operations S107 and S108. Thereafter, in operation S109, a notification indicating completion of the preparation is sent from the output-channel switching controller 312 to the sound-source apparatus 150.

After the issuance of the notification, the L-side audio signal and R-side audio signal sent from the sound-source apparatus 150 are appropriately distributed by the changeover switch 114c for which the preparation has been completed as described above, the distributed audio signals are amplified by the amplifying unit 112, and the amplified audio signals are input to the corresponding speakers 111 and 121.

The audio-signal inputting to the speakers in operation S109 is continuously performed while the power switch (not illustrated) of the first speaker unit 310 is on (i.e., No in operation S110). When the power switch is turned off (i.e., Yes in operation S110), the sound output processing illustrated in the flowchart of FIG. 21 ends.

As described above, the speaker system 300 of the fourth embodiment also allows the user to arbitrarily place the two speaker units 310 and 320.

In the fourth embodiment, the directional radio-wave signal transmitted by the wireless tag 321a in the second speaker unit 320 is used as a wireless signal for determining the placement of the two speaker units 310 and 320. As a result, in the fourth embodiment, through the very simple determination as to whether or not the directional radio-wave signal is received by the wireless receiver 311a in the first speaker unit 310, the placement of the two speaker units 310 and 320 is determined.

This means that an applied form as described below is preferably applicable to the speaker system of the present disclosure. In this applied form, the transmitter described above transmits, as the wireless signal, a signal having directivity. In this applied form, the sensor detects the signal having directivity. In the applied form, the placement determiner determines the position of the transmitter relative to the position of the sensor, on the basis of whether the signal is detected by the sensor. By determining the relative position of the transmitter, the placement determiner determines the placement of the speaker units.

The wireless tag 321a in the fourth embodiment is one example of the transmitter in the applied form. The wireless receiver 311a in the fourth embodiment is one example of the placement sensor in the applied form.

Although the speaker system including the plurality of speaker units has been exemplified in the first to fourth embodiments as the signal processing system according to the present disclosure, the signal processing system according to the present disclosure is not limited thereto. Examples of the signal processing system according to the present disclosure include an image display system having a plurality of display apparatuses and a computer system having a plurality of computer apparatuses.

In the second to fourth embodiments described above, a signal processing system (a speaker system) including two processing apparatuses (two speaker units) has been exemplified as the signal processing system and the speaker system according to the present disclosure. However, the signal processing system and the speaker system according to the present disclosure are not limited to the example. The signal processing system and the speaker system according to the present disclosure may have three or more processing apparatuses (speaker units). In such a case, the placement of the processing apparatuses (the speaker units) is determined using, for example, a method utilizing triangulation. In this method, one of the processing apparatuses (the speaker units) has a set of two sensors and the other one of the processing apparatuses (the speaker units) has a transmitter of a wireless signal. Two sensors detect the wireless signal transmitted from the transmitter, and results of the detection performed by the sensors are used to perform triangulation. With this arrangement, the position of the processing apparatus (the speaker unit) having the transmitter relative to the processing apparatus (the speaker unit) having two sensors is determined. Such triangulation is repeatedly performed for each processing apparatus as appropriate to determine the placement of the processing apparatuses (the speaker units).

In the embodiments described above, a form in which the sensor and the transmitter are provided in different processing apparatuses (speaker units) has been exemplified as the signal processing system and the speaker system according to the present disclosure. However, the signal processing system and the speaker system according to the present disclosure are not limited to the above-described embodiments. The signal processing system and the speaker system according to the present disclosure may take a form in which one or more of the processing apparatuses (the speaker units) have both of the sensor and the transmitter. Such a form is similar to the above-described embodiments in that the position of one processing apparatus (the speaker unit) having the transmitter relative to another processing apparatus having the sensor is determined.

In the embodiments described above, a form in which the sensor and the transmitter are provided in the corresponding processing apparatuses (speaker units) has been exemplified as the signal processing system and the speaker system according to the present disclosure. However, the signal processing system and the speaker system according to the present disclosure are not limited to the above-described embodiments. For example, the signal processing system and the speaker system according to the present disclosure may take a form in which each of the processing apparatuses (the speaker units) has one of the sensor and the transmitter and the other one is placed outside the processing apparatuses (the speaker units). In such a case, through determination of the positions of the processing apparatuses (speaker units) relative to the sensor or the transmitter placed outside the processing apparatuses, the relative position between the processing apparatuses is determined.

In the embodiments described above, forms that employ a radio-wave signal and test sound have been exemplified as one example of the wireless signal for apparatus placement determination. However, the signal processing system and the speaker system according to the present disclosure are not limited to these embodiments. The signal processing system and the speaker system according to the present disclosure may employ a medium such as infrared or light as the wireless system for apparatus placement determination. According to an aspect of an embodiment, source signals transmitted from a source to the processing apparatuses may be transmitted by wire and/or wirelessly.

According to an aspect of the embodiments of the invention, any combinations of one or more of the described features, functions, operations, and/or benefits can be provided. A combination can be one or a plurality. The embodiments can be implemented as an apparatus (a machine) that includes computing hardware (i.e., computing apparatus), such as (in a non-limiting example) any computer that can store, retrieve, process and/or output data and/or communicate (network) with other computers. According to an aspect of an embodiment, the described features, functions, operations, and/or benefits can be implemented by and/or use computing hardware and/or software. The described apparatus(es) (e.g., transmitter 20, sensor 30, the placement determiner 40 and the audio-signal distributor 50 (e.g., switching controller 114), etc.) can be implemented by a combination of hardware (e.g., speaker, wireless transmitter tag), hardware logic circuitry and/or computing hardware that includes a controller (CPU) (e.g., a hardware logic circuitry based computer processor that processes or executes instructions, namely software/program), computer readable media, transmission communication interface (network interface), and/or an output device, for example, a display device, all in communication through a data communication bus. In addition, an apparatus can include one or more apparatuses in computer network communication with each other or other apparatuses. In addition, a computer processor can include one or more computer processors in one or more apparatuses or any combinations of one or more computer processors and/or apparatuses. An aspect of an embodiment relates to causing one or more apparatuses and/or computer processors to execute the described operations. The results produced can be output to an output device, for example, displayed on the display.

A program/software implementing the embodiments may be recorded on a computer-readable media, e.g., a non-transitory or persistent computer-readable medium. Examples of the non-transitory computer-readable media include a magnetic recording apparatus, an optical disk, a magneto-optical disk, and/or volatile and/or non-volatile semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), DVD-ROM, DVD-RAM (DVD-Random Access Memory), BD (Blue-ray Disk), a CD-ROM (Compact Disc-Read Only Memory), and a CD-R (Recordable)/RW. The program/software implementing the embodiments may be transmitted over a transmission communication path, e.g., a wire and/or a wireless network implemented via hardware. An example of communication media via which the program/software may be sent includes, for example, a carrier-wave signal.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A signal processing system that processes a signal from a source, comprising:
a transmitter that transmits a wireless signal for apparatus placement determination;
a sensor that detects the wireless signal transmitted by the transmitter;
a plurality of processing apparatuses that receive corresponding signals and execute processing on the received signals, each processing apparatus in communication with the transmitter and/or the sensor;
a placement determiner that determines placement of the processing apparatuses based on the detection of the wireless signal by the sensor; and
a signal distributor that distributes and sends signals from the source to the processing apparatuses respectively, on a basis of the placement determined by the placement determiner.

2. The signal processing system according to claim 1, wherein the sensor comprises a set of sensors arranged at respective different positions,
each of the processing apparatuses includes the transmitter and/or the set of sensors; and
the placement determiner determines the placement of the processing apparatuses by determining a position of the transmitter relative to the set of sensors using strengths of the wireless signal detected by the sensors of the set of sensors.

3. The signal processing system according to claim 2, wherein the placement determiner determines the position of the transmitter relative to the set of sensors on a basis of magnitude comparison of the strengths of the wireless signal detected by the sensors.

4. The signal processing system according to claim 1, wherein the transmitter transmits a signal having directivity as the wireless signal,
the sensor detects the signal having directivity, and
the placement determiner determines the placement of the processing apparatuses by determining a position of the transmitter relative to a position of the sensor on a basis of whether the sensor detects the signal having directivity.

5. The signal processing system according to claim 1, wherein the signals from the source are audio signals representing sound,
the processing apparatuses are speaker units including respective speakers, and
the signal distributor distributes and sends the audio signals to the speaker units respectively on a basis of the placement determined by the placement determiner.

6. The signal processing system according to claim 5, wherein the speaker included in the speaker unit doubles as the transmitter and transmits sound as the wireless signal for determining the placement of the speaker units, and
each of the sensors is a microphone for detecting sound.

7. A method of processing a signal from a source, comprising:
transmitting a wireless signal for apparatus placement determination by a transmitter provided for a first processing apparatus of a plurality of processing apparatuses;
detecting the wireless signal by a sensor provided for a second processing apparatus of the plurality of processing apparatuses;
determining placement of the first processing apparatus and the second processing apparatus on a basis of the detection of the wireless signal by the sensor; and
distributing and sending signals from the source to the first processing apparatus and the second processing apparatus, on a basis of the determining.

8. The signal processing method according to claim 7, wherein the sensor comprises a set of sensors arranged at respective different positions in the second processing apparatuses, and
the determining determines the placement of the first processing apparatus and the second processing apparatus by determining a position of the transmitter relative to the set of sensors using strengths of the wireless signal detected by the sensors of the set of sensors.

9. The signal processing method according to claim 8, wherein the determining determines the position of the transmitter relative to the set of sensors on a basis of magnitude comparison of the strengths of the wireless signal detected by the sensors.

10. The signal processing method according to claim 7, wherein the transmitter transmits a signal having directivity as the wireless signal,
the sensor detects the signal having directivity, and
the determining determines the placement of the processing apparatuses by determining a position of the transmitter relative to a position of the sensor on a basis of whether the sensor detects the signal having directivity.

11. The signal processing method according to claim 7, wherein the signals from the source are audio signals representing sound,
the first processing apparatus and the second processing apparatus are speaker units including respective speakers, and
the sending sends the distributed audio signals to the speaker units respectively on a basis of the placement determined by the determining.

12. The signal processing method according to claim 11, wherein the speaker included in the speaker unit doubles as the transmitter and transmits sound as the wireless signal for determining the placement of the speaker unit, and
each of the sensors is a microphone for detecting sound.

13. A method of processing a signal from a source by a signal processing system that includes a plurality of processing apparatuses, comprising:
providing a wireless transmitter for one of the processing apparatuses;
providing a sensor for an other of the processing apparatuses;
configuring the signal processing system to execute:
transmitting by the transmitter provided for the one processing apparatus a wireless signal for determining placement of a processing apparatus;
detecting the wireless signal by the sensor provided for the other processing apparatus;
determining placement of the one processing apparatus and the other processing apparatus based upon detection of the wireless signal by the sensor; and
distributing and sending signals from the source to the one processing apparatus and the other processing apparatus, based upon the processing apparatus placement determination.
